(19) United States
(12) Patent Application Publication
(10) Pub. No.: US 2024/0043609 A1
(43) Pub. Date: Feb. 8, 2024

(54) NOVEL THERMOPLASTIC POLYESTERS AND SYNTHESIS THEREFOR

(71) Applicant: Eastman Chemical Company, Kingsport, TN (US)

(72) Inventors: Kate Elizabeth Allen, Jonesborough, TN (US); Jason Christopher Jenkins, Kingsport, TN (US)

(73) Assignee: Eastman Chemical Company, Kingsport, TN (US)

(21) Appl. No.: 18/257,454

(22) PCT Filed: Dec. 16, 2021
(86) PCT No.: PCT/US2021/063664

§ 371 Date: Jun. 14, 2023

Related U.S. Application Data
(60) Provisional application No. 63/199,303, filed on Dec. 18, 2020.
(60) Provisional application No. 63/199,304, filed on Dec. 18, 2020.
(60) Provisional application No. 63/199,305, filed on Dec. 18, 2020.
(60) Provisional application No. 63/199,306, filed on Dec. 18, 2020.
(60) Provisional application No. 63/199,308, filed on Dec. 18, 2020.
(60) Provisional application No. 63/199,309, filed on Dec. 18, 2020.
(60) Provisional application No. 63/199,310, filed on Dec. 18, 2020.

(51) Int. Cl. C08G 63/183; C08G 63/137; C08G 63/84; C08G 63/85; C08G 63/83

(52) U.S. Cl. CPC C08G 63/183; C08G 63/137; C08G 63/84; C08G 63/85; C08G 63/83

(57) ABSTRACT

This invention relates to a process for making at least one polyester comprising: (a) a dicarboxylic acid component comprising: (i) 70 to 100 mole % of terephthalic acid residues; (ii) 0 to 30 mole % of aromatic dicarboxylic acid residues having up to 20 carbon atoms; and (iii) 0 to 10 mole % of aliphatic dicarboxylic acid residues having up to 16 carbon atoms; (b) a glycol component comprising: (i) 10 to 50 mole % of 2,2,4,4-tetramethyl-1,3-cyclobutanediol residues, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2, 2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2, 2,4,4-tetramethyl-1,3-cyclobutanediol and less than 5 mole % of trans-2,2,4,4-tetramethyl-1,3-cyclobutanediol; (ii) 50 to 90 mole % of cyclohexanedimethanol residues; and (iii) optionally, residues of at least one modifying glycol; wherein the total mole % of the dicarboxylic acid component of the final polyester is 100 mole %; wherein the total mole % of the glycol component of the final polyester is 100 mole %; and wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

### FIELD OF THE INVENTION

The present invention relates to polyesters, polyester compositions, and/or processes of making polyesters and/or polyester compositions wherein the polyesters comprise residues of terephthalic acid and/or ester(s) thereof, high cis-2,2,4,4-tetramethyl-1,3-cyclobutanediol (TMCD), and 1,4-cyclohexanedimethanol (CHDM). The process employs the use high cis-TMCD and, optionally, redox inactive catalysts, resulting in good TMCD incorporation, improved color, improved TMCD yield, and reactivity sufficient to achieve desired inherent viscosities over a broad compositional range.

### BACKGROUND OF THE INVENTION

Tin (Sn) based catalysts are typically the most efficient at incorporating TMCD into a polyester (Caldwell et al. CA 740050, and Kelsey et al., Macromolecules 2000, 33, 581). However, tin based catalysts typically produce a yellow to amber colored copolyester in the presence of EG, e.g., see Kelsey, U.S. Pat. No. 5,705,575; and Morris et al., U.S. Pat. No. 5,955,565.

Titanium (Ti) based catalysts are reported to be ineffective at incorporating TMCD into a polyester (Caldwell et al. CA 740050, Kelsey et al., Macromolecules 2000, 33, 5810).

United States Patent Application No. 2007/0142511 discloses that polyesters with a glycol component comprising TMCD and ethylene glycol (EG), and optionally, certain levels of CHDM, can be prepared with titanium based catalysts. It indicates that TMCD incorporation can be improved by use of tin based catalysts in addition to titanium based catalysts. It further indicates that the color of the copolyesters of the invention can be improved with the addition of certain levels of phosphorus containing compounds. This publication discloses a wide compositional range with a glycol component comprising: (i) about 1 to about 90 mole % TMCD residues; and (ii) about 99 to about 10 mole % EG residues. However, whenever relatively high levels of EG were present, e.g., polymers with only TMCD and EG, the catalyst system required a significant amount of Sn.

Polyesters comprising TMCD residues and CHDM residues have been manufactured using a tin polymerization catalyst.

However, there is a commercial need for an novel polyesters, novel polyester compositions, and alternative processes of making polyesters wherein the polyesters have a combination of properties making it more useful for injection molding, blow molding, extrusion, and thermoformed film and sheet applications including a combination one or more, two or more, or three or more of the following properties: good notched Izod impact strength, good inherent viscosities, good glass transition temperature (Tg), good flexural modulus, good tensile strength, good clarity, good color, good dishwasherability, good TMCD incorporation, good TMCD yield, and good/improved melt stability.

### SUMMARY OF THE INVENTION

In one aspect, this invention relates to polyesters, polyester compositions, and/or processes of making polyesters and/or polyester compositions comprising residues of CHDM and high cis-TMCD.

In one aspect, this invention relates to a polyester composition comprising at least one polyester further comprising:
(a) a dicarboxylic acid component comprising:
   (i) 70 to 100 mole % of residues of terephthalic acid and/or at least one ester thereof;
   (ii) 0 to 30 mole % of aromatic dicarboxylic acid residues having up to 20 carbon atoms; and
   (iii) 0 to 10 mole % of aliphatic dicarboxylic acid residues having up to 16 carbon atoms;
(b) a glycol component comprising:
   (i) 10 to 50 mole % of 2,2,4,4-tetramethyl-1,3-cyclobutanediol residues, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol;
   (ii) 50 to 90 mole % of cyclohexanedimethanol residues; and
   (iii) optionally, residues of at least one modifying glycol;
wherein the total mole % of the dicarboxylic acid component of the final polyester is 100 mole %;
wherein the total mole % of the glycol component of the final polyester is 100 mole %; and
wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one aspect, this invention relates to a process for preparing a polyester composition comprising at least one polyester further comprising:
(a) a dicarboxylic acid component comprising:
   (i) 70 to 100 mole % of residues of terephthalic acid and/or at least one ester thereof;
   (ii) 0 to 30 mole % of aromatic dicarboxylic acid residues having up to 20 carbon atoms; and
   (iii) 0 to 10 mole % of aliphatic dicarboxylic acid residues having up to 16 carbon atoms;
(b) a glycol component comprising:
   (i) 10 to 50 mole % of 2,2,4,4-tetramethyl-1,3-cyclobutanediol residues, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol;
   (ii) 50 to 90 mole % of cyclohexanedimethanol residues; and
   (iii) optionally, residues of at least one modifying glycol;
wherein the total mole % of the dicarboxylic acid component of the final polyester is 100 mole %;
wherein the total mole % of the glycol component of the final polyester is 100 mole %; and wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one aspect, this invention relates to novel polyesters and/or polyester compositions and novel processes for their manufacture wherein the polyesters and/or polyester compositions comprise residues of CHDM and of high cis-TMCD and, optionally, using a catalyst system comprising: (a) lithium atoms and aluminum atoms; or (b) titanium and zinc atoms; or (c) tin atoms.

In one aspect, this invention relates to novel polyesters and/or polyester compositions and novel processes for their manufacture wherein the polyesters and/or polyester compositions comprise residues of CHDM and of high cis-TMCD and using a catalyst system comprising redox inactive catalysts. Certain redox inactive catalyst systems can comprise: (a) lithium atoms and aluminum atoms; or (b) titanium and zinc atoms.

It is unpredictable for these polyesters and/or polyester compositions of the invention to have similar properties when using the catalyst system of the invention compared to when tin is alternatively used as a catalyst to make these polyesters. In the lithium and aluminum catalyst system, it is also unpredictable that neither tin or titanium is required to obtain a polyester and/or polyester composition with similar properties.

In one aspect, the polyesters and/or polyester compositions of the invention can have a combination of one or more, two or more, or three or more of the following properties: good notched Izod impact strength, good inherent viscosities, good glass transition temperature (Tg), good flexural modulus, good tensile strength, good clarity, good color, good dishwasherability, good TMCD incorporation, good TMCD yield, and good/improved melt stability.

Additionally, it is unpredictable that the catalyst systems useful in the invention have sufficient reactivity to achieve the desired inherent viscosity (IV) over the entire polyester compositional range that includes: (a) a dicarboxylic acid component comprising: (i) 70 to 100 mole % terephthalic acid and/or dimethyl terephthalate residues; and (ii) about 0 to about 30 mole % of aromatic and/or aliphatic dicarboxylic acid residues having up to 20 carbon atoms; and (b) a glycol component comprising about 10 to about 50 mole % 2,2,4,4-tetramethyl-1,3-cyclobutanediol (TMCD) residues and about 50 to about 90 mole % 1,4-cyclohexanedimethanol residues, based on the glycol component totaling 100 mole % and the diacid component totaling 100 mole %.

In one aspect of the invention, the use of high cis-TMCD can change the typical TMCD degradation route, and, unpredictably, can enable higher TMCD yield to a degree not observed previously with other process enhancements.

In one aspect of the invention, the use of the catalyst systems of the invention in combination with the use of high cis-TMCD, unpredictably, can change the typical TMCD degradation route and can enable even higher TMCD yield to a degree not observed previously with other process enhancements.

In one aspect of the invention, a process for making at least one polyester is provided comprising the following steps:
(I) heating a mixture of at least one temperature chosen from 150° C. to 300° C., under at least one pressure chosen from the range of 0 psig to 100 psig wherein said mixture comprises:
   (a) a dicarboxylic acid component comprising:
      (i) 70 to 100 mole % residues of terephthalic acid and/or at least one ester thereof;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms;
   (b) a glycol component comprising:
      (i) 10 to 50 mole % of TMCD which is a combination of greater than 70 mole % of cis-TMCD and less than 30 mole % of trans-TMCD, or greater than 75 mole % of cis-TMCD and less than 25 mole % of trans-TMCD, or greater than 80 mole % of cis-TMCD and less than 20 mole % of trans-TMCD, or greater than 85 mole % of cis-TMCD and less than 15 mole % of trans-TMCD, or greater than 90 mole % of cis-TMCD and less than 10 mole % of trans-TMCD, or greater than 95 mole % of cis-TMCD and less than 5 mole % of trans-TMCD;
      (ii) 50 to 90 mole % of CHDM residues; and
      (iii) optionally, residues of at least one modifying glycol;
   wherein the molar ratio of glycol component/dicarboxylic acid component added in Step (I) is 1.0-1.5/1.0;
(II) heating the product of Step (I) at a temperature of 230° C. to 320° C. for 1 to 6 hours, under at least one pressure chosen from the range of the final pressure of Step (I) to 0.02 torr absolute, to form a final polyester;
   wherein the total mole % of the dicarboxylic acid component of the final polyester is 100 mole %;
   wherein the total mole % of the glycol component of the final polyester is 100 mole %; and
   wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one aspect, the mixture in Step (I) can be heated in the presence of at least one catalyst system comprising:
(i) at least one lithium compound and at least one aluminum compound; or
(ii) at least one titanium compound and at least one zinc compound; or

(iii) at least one tin compound.

In one aspect, the mixture in Step (I) is heated in the presence of a first catalyst, and Step II is heated in the presence of a second catalyst, and wherein the catalyst system comprises one of the following:
(i) the first catalyst comprises at least one lithium compound and the second catalyst comprises at least one aluminum compound; or
(ii) the first catalyst comprises at least one titanium compound and a second catalyst comprising at least one zinc compound.

In one aspect, the catalyst system utilized in the process(es) of the invention comprises lithium atoms and aluminum atoms. In this aspect, tin atoms can be present in the final polyester in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared. Optionally, also, titanium atoms can be present in the final polyester and/or polyester composition in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one aspect, the catalyst system utilized in the process(es) of the invention comprises titanium atoms and zinc atoms. In this aspect, tin atoms can be present in the final polyester and/or polyester composition in an amount of less than 30 ppm, or less than 20 ppm, or less than 10 ppm, or less than 5 ppm, or from 0 to 30 ppm, or from 0 to 20 ppm, or from 0 to 10 ppm, or ppm, relative to the mass of final polyester being prepared.

In one aspect, the polyesters and/or polyester compositions of the invention can comprise residues of TMCD in the amount of from about 10 to about 45 mole, or from about 10 to about 40 mole %, or from about 10 to about 35 mole %, or from about 20 to about 45 mole, or from about 20 to about 40 mole %, or from about 20 to about 35 mole %, or from about 25 to about 45 mole, or from about 25 to about 40 mole %, or from about 30 to about 35 mole %.

In one aspect, the polyesters and/or polyester compositions of the invention can comprise CHDM residues in the amount of from about 55 to about 90 mole %, or from about 60 to about 90 mole %, or from about 65 to about 90 mole %, or from about 55 to about 80 mole %, or from about 55 to about 75 mole %, or from about 60 to about 80 mole %, or from about 65 to about 80 mole %, or from about 60 to about 75 mole %, or from about 65 to about 70 mole %.

In one aspect, the polyesters and/or polyester compositions of the invention can comprise residues of TMCD in the amount of 20 to 45 mole % and residues of CHDM in the amount of 55 to 80 mole %, or residues of TMCD in the amount of 20 to 40 mole % and residues of CHDM in the amount of 60 to 80 mole %, or residues of TMCD in the amount of 20 to 35 mole % and residues of CHDM in the amount of 65 to 80 mole %, or 25 to 45 mole % and residues of CHDM in the amount of 55 to 75 mole %, or residues of TMCD in the amount of 25 to 40 mole % and residues of CHDM in the amount of 60 to mole %, or residues of TMCD in the amount of 25 to 35 mole % and residues of CHDM in the amount of 65 to 75 mole %; or residues of TMCD in the amount of 30 to 35 mole % and residues of CHDM in the amount of 65 to mole %.

In one aspect, the polyesters and/or polyester compositions of the invention can have a molar ratio of TMCD:CHDM from 1:9 to 1:1, or from 1:4 to 1:1, or from or from 1:3 to 1:1.5, or from 1:3 to 1:1, or from 1:2 to 1:1, or from 1:1.5 to 1:1.

In one aspect, the polyesters and/or polyester compositions of the invention can comprise TMCD residues which are a combination of greater than 70 mole % of cis-TMCD and less than 30 mole % of trans-TMCD, or greater than 75 mole % of cis-TMCD and less than 25 mole % of trans-TMCD, or greater than 80 mole % of cis-TMCD and less than 20 mole % of trans-TMCD, or greater than 85 mole % of cis-TMCD and less than 15 mole % of trans-TMCD, or greater than 90 mole % of cis-TMCD and less than 10 mole % of trans-TMCD, or greater than 95 mole % of cis-TMCD and less than 5 mole % of trans-TMCD.

In one aspect, can comprise high cis-TMCD residues in the amount of 90 mole % or greater; and trans-TMCD residues in the amount of 10 mole % or less, or cis-TMCD residues in the amount of 95 mole % or greater; and trans-TMCD residues in the amount of 5 mole % or less.

In one aspect of the invention, the polyesters and/or polyester compositions of the invention can comprise modifying glycols which include but are not limited to at least one of diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or combinations thereof.

In certain aspects of the invention, the polyesters and/or polyester compositions of the invention can contain less than about 2 mole % of a second modifying glycol having from 3 to 16 carbon atoms. In certain embodiments, the polyester contains no other added modifying glycols. It should be understood that some other glycol residues may be formed in situ during processing.

In one aspect, the polyester compositions and/or polyesters of the invention can comprise no hexanediol, and/or no propanediol, and/or no butanediol.

In one aspect of the invention, the polyester compositions and/or polyesters of the invention can comprise residues of ethylene glycol or can comprise no residues of ethylene glycol.

In one aspect of the invention, the polyester compositions and/or polyesters of the invention can comprise less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues.

In one aspect of the invention, the diacid component of at least one polyester of the invention can comprise aromatic and/or aliphatic dicarboxylic acid ester residues.

In one aspect of the invention, the diacid component of the polyesters of the invention can comprise residues of dimethyl terephthalate.

In one aspect of the invention, the polyesters and/or polyester compositions of the invention can comprise aromatic and/or aliphatic dicarboxylic acid ester residues in an amount of less than 30 mole %, or less than 20 mole %, or less than 10 mole %, or less than 5 mole %, or from 0 to 30 mole %, or from 0 to 20 mole %, or from 0 to 10 mole %, or 0 mole, based on the total mole percentages of diacid residues in the final polyester equaling 100 mole %.

In one aspect of the invention, the polyesters and/or polyester compositions of the invention can comprise CHDA residues, e.g., trans-CHDA, in an amount of less than 30 mole %, or less than 20 mole %, or less than 10 mole %, or less than 5 mole %, or from 0 to 30 mole %, or from 0 to 20 mole %, or from 0 to 10 mole %, or 0 mole, based on the total mole percentages of diacid residues in the final polyester equaling 100 mole %.

In one aspect of the invention, the polyesters and/or polyester compositions of the invention can comprise lithium atoms and/or aluminum atoms in the amount of from 5 to 500 ppm, or from 5 to 450 ppm, or from 5 to 400 ppm, or 5 to 350 ppm, or 5 to 300 ppm, or from 5 to 250 ppm, or from 5 to 200 ppm, or from 5 to 150 ppm, or from 5 to 125 ppm, or from 5 to 100 ppm, or from 5 to 90 ppm, or from 5 to 85 ppm, or from 5 to 80 ppm, or from 5 to 75 ppm, or from 5 to 70 ppm, or from 5 to 65 ppm, or from 5 to 60 ppm, or 10 to 500 ppm, or from 10 to 450 ppm, or from 10 to 400 ppm, or 10 to 350 ppm, or from 10 to 300 ppm, or from 10 to 250 ppm, or from 10 to 200 ppm, or from 10 to 150 ppm, or from 10 to 125 ppm, or from 10 to 100 ppm, or from 10 to 90 ppm, or from 10 to 80 ppm, or from 10 to 75 ppm, or from 10 to 70 ppm, or from 10 to 65 ppm, or from 10 to 60 ppm, or from 25 to 500 ppm, or from 25 to 450 ppm, or from 25 to 400 ppm, or 25 to 350 ppm, or from 25 to 300 ppm, or from 25 to 250 ppm, or from 25 to 200 ppm, or from 25 to 150 ppm, or from 25 to 125 ppm, or from 25 to 100 ppm, or from 25 to 90 ppm, or from 25 to 80 ppm, or from 25 to 75 ppm, or from 25 to 70 ppm, or from 25 to 65 ppm, or from 25 to 60 ppm, or from 30 to 500 ppm, or from 30 to 450 ppm, or from 30 to 400 ppm, or 30 to 350 ppm, or from 30 to 300 ppm, or from 30 to 250 ppm, or from 30 to 200 ppm, or from 30 to 150 ppm, or from 30 to 100 ppm, or from 30 to 90 ppm, or from 30 to 80 ppm, or from 30 to 75 ppm, or from 30 to 70 ppm, or from 30 to 65 ppm, or from 30 to 60 ppm, or from 40 to 500 ppm, or from 40 to 450 ppm, or from 40 to 400 ppm, or 40 to 350 ppm, or from 40 to 300 ppm, or from 40 to 250 ppm, or from 40 to 200 ppm, or from 40 to 150 ppm, or from 40 to 100 ppm, or from 40 to 90 ppm, or from 40 to 80 ppm, or from 40 to 75 ppm, or from 40 to 70 ppm, or from 40 to 65 ppm, or from 40 to 60 ppm, or from 50 to 500 ppm, or from 50 to 450 ppm, or from 50 to 400 ppm, or 50 to 350 ppm, or from 50 to 300 ppm, or from 50 to 250 ppm, or from 50 to 200 ppm, or from 50 to 150 ppm, or from 50 to 100 ppm, or from 50 to 90 ppm, or from 50 to 80 ppm, or from 50 to 75 ppm, or from 50 to 70 ppm, or from 50 to 65 ppm, or from 50 to 60 ppm, relative to the mass of final polyester being prepared.

In one aspect, the amount of lithium atoms and/or aluminum atoms present in the polyesters and/or polyester compositions generally can range from at least 5 ppm, or at least 8 ppm, or at least 10 ppm, or at least 15 ppm, or at least 20 ppm, or at least 25 ppm, or at least 30 ppm, or at least 35 ppm, or at least 40 ppm, or at least 45 ppm, or at least 50 ppm, and less than 100 ppm, or less than 90 ppm, or less than 80 ppm, or less than 75 ppm, or less than 70 ppm, or less than 65 ppm, or less than 60 ppm, based on the total weight of the polymer.

In one aspect, the catalyst system utilized in the process(es) of the invention comprises lithium atoms and/or aluminum atoms, wherein the lithium atoms are present in the final polyester in the amount of from 10 ppm to 100 ppm, or 20 ppm to 100 ppm, or 25 ppm to 100 ppm, or 30 ppm to 100 ppm, or 35 ppm to 100 ppm, or 40 ppm to 100 ppm, or 45 ppm to 100 ppm, or 50 ppm to 100 ppm, or 10 ppm to 75 ppm, or 15 ppm to 75 ppm, or 20 ppm to 75 ppm, or 25 ppm to 75 ppm, or 30 ppm to 75 ppm, or 35 ppm to 75 ppm, or 40 ppm to 75 ppm, or 45 ppm to 75 ppm, or 50 ppm to 75 ppm, or 10 ppm to 65 ppm, or 20 ppm to 65 ppm, or 30 ppm to 65 ppm, or 35 ppm to 65 ppm, or 40 ppm to 65 ppm, or 45 ppm to 65 ppm, or 50 ppm to 65 ppm, relative to the mass of final polyester being prepared.

In one aspect, the catalyst system utilized in the process(es) of the invention comprises lithium atoms and/or aluminum atoms, wherein the total catalyst metal atoms of lithium and aluminum present in the final polyester is in the range of from 10 to 1000 ppm, or from 10 to 800 ppm, or from 10 to 600 ppm, or from 10 to 500 ppm, or from 10 to 400 ppm, or from 10 to 300 ppm, or from 10 to 250 ppm, or from 10 to 200 ppm, or from 10 to 150 ppm, or from 50 to 1000 ppm, or from 50 to 800 ppm, or from 50 to 600 ppm, or from 50 to 500 ppm, or from 50 to 400 ppm, or from 50 to 300 ppm, or from 50 to 250 ppm, or from 50 to 200 ppm, or from 50 to 150 ppm, or from 100 to 1000 ppm, or from 100 to 800 ppm, or from 100 to 600 ppm, or from 100 to 500 ppm, or from 100 to 400 ppm, or from 100 to 300 ppm, or from 100 to 250 ppm, or from 100 to 200 ppm, or from 200 to 1000 ppm, or from 200 to 800 ppm, or from 200 to 600 ppm, or from 200 to 500 ppm, or from 200 to 400 ppm, relative to the mass of final polyester being prepared.

In one aspect, the catalyst system utilized in the process(es) of the invention comprises lithium atoms and aluminum atoms, wherein the ratio of lithium atoms to aluminum atoms as measured in ppm is from 1:5 to 5:1, or from 1:4 to 4:1, or from 1:3 to 3:1, or from 1:2 to 2:1; or from 1:1, relative to the mass of final polyester being prepared.

In one aspect, the catalyst system utilized in the process(es) of the invention comprises lithium atoms and aluminum atoms, wherein at least one lithium source can be selected from, but is not limited to, lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, or alkyl lithium, lithium aluminum hydride, lithium borohydride, lithium oxide.

In one aspect, the catalyst system utilized in the process(es) of the invention comprises lithium atoms and aluminum atoms, wherein at least one lithium source is lithium acetylacetonate.

In one aspect, the catalyst system utilized in the process(es) of the invention comprises lithium and aluminum, wherein at least one aluminum source can be selected from, but is not limited to, aluminum acetate, aluminum benzoate, aluminum sulfate, aluminum lactate, aluminum laurate, aluminum stearate, aluminum alcoholates, aluminum ethylate, aluminum isopropoxide, aluminum trin-butyrate, aluminum tri-Cert-butyrate, mono-sec-butoxyaluminum diisopropylate, and aluminum chelates, ethyl acetoacetate aluminum diisopropylate, aluminum tris(ethyl acetoacetate), alkyl acetoacetate, aluminum diisopropylate, aluminum monoacetylacetate bis(ethyl acetoacetate), aluminum tris(acetyl acetate), or aluminum acetylacetonate.

In one aspect, the catalyst system utilized in the process(es) of the invention comprises lithium and aluminum, wherein at least one aluminum compound can be selected from, but is not limited to, from aluminum hydroxide, aluminum acetylacetonate, aluminum acetate, aluminum isopropoxide or aluminum sulfate.

In one aspect, the catalyst system utilized in the process(es) of the invention comprises lithium and aluminum, wherein at least one aluminum compound can be selected from, but is not limited to, at least one of aluminum acetylacetonate and aluminum isopropoxide.

In one aspect, the catalyst system utilized in the process(es) of the invention comprises titanium atoms and zinc atoms, wherein at least one titanium source can be selected from, but is not limited to, at least one of titanium carbonate, titanium acetate, titanium benzoate, titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide.

In one aspect, the catalyst system utilized in the process(es) of the invention comprises titanium atoms and zinc atoms, wherein at least one titanium source can be selected from at least one of titanium dioxide, titanium isopropoxide, titanium acetylacetonate oxide, titanium bis(acetylacetonate)di-isopropoxide and/or combinations thereof.

In one aspect, the catalyst system utilized in the process(es) of the invention can comprise titanium atoms and zinc atoms, wherein at least one zinc source can be selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, diallyl zinc, dimethyl zinc, diaryl zinc, zinc isopropoxide, zinc phosphate, and/or zinc acetylacetonate.

In one aspect, the catalyst system utilized in the process(es) of the invention can comprise titanium atoms and zinc atoms, wherein at least one titanium source can be selected from at least one of zinc acetylacetonate and zinc isopropoxide.

In one aspect, the catalyst system utilized in the process(es) of the invention comprises titanium atoms and zinc atoms, wherein the titanium atoms present in the final polyester is in the range of from 20 to 750 ppm, or from 20 to 500 ppm, or from 20 to 450 ppm, or from 20 to 400 ppm, or from 20 to 350 ppm, or from 20 to 300 ppm, or from 20 to 275 ppm, or from 20 to 250 ppm, or from 20 to 200 ppm, or from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one aspect, the catalyst system utilized in the process(es) of the invention comprises titanium atoms and zinc atoms, wherein the total catalyst metal atoms present in the final polyester is in the range of from 150 to 800 ppm, or from 150 to 725 ppm, or from 150 to 700 ppm, or from 150 to 500 ppm, or from 150 to 450 ppm, or from 150 to 400 ppm, or from 150 to 300 ppm, 200 to 800 ppm, or from 200 to 725 ppm, or from 200 to 700 ppm, or from 200 to 600 ppm, or from 200 to 500 ppm, or from 200 to 450 ppm, or from 200 to 400 ppm, or from 200 to 300 ppm, or from 250 to 800 ppm, or from 250 to 725 ppm, or from 250 to 700 ppm, or from 250 to 500 ppm, or from 250 to 450 ppm, or from 250 to 400 ppm, or from 300 to 800 ppm, or from 300 to 725 ppm, or from 300 to 700 ppm, or from 300 to 500 ppm, or from 300 to 450 ppm, or from 300 to 400 ppm, or from 350 to 800 ppm, or from 350 to 725 ppm, or from 350 to 700 ppm, or from 350 to 500 ppm, or from 350 to 450 ppm, relative to the mass of final polyester being prepared.

In one aspect, the catalyst system utilized in the process(es) of the invention comprises titanium atoms and zinc atoms, wherein the ratio of titanium atoms to zinc atoms in ppm relative to the mass of final polyester being prepared is from 0.50-1:5 to 5:1, or from 0.50-1:4 to 4:1, or from 0.50-1:3 to 3:1, or from 0.50:1 to 1:5, or from 0.50-1 to 1:4, or from 0.60-1:5 to 5:1, or from 0.60-1:4 to 4:1, or from 0.60-1:3 to 3:1, or from 0.60:1 to 1:5, or from to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 0.75-1:3 to 3:1, or from 0.75-1:2 to 2:1, or from 0.75-1.0 to 1:4, or from 0.80:1.2 to 1:4, or from 1.0 to 1.5:1.0 to 1:7.1, or from 1.0 to 1.5:1.0 to 3, or from 1.0 to 1.5:1.0 to 2, or from 1.0 to 1.5:1.0 to 2.5, or from (0.80-1):5 to 5:1, or from (0.80-1):5 to 5:1, or from (0.80-1.44 to 4:1, 1:4 to 4:1, or from (0.80-1):3 to 3:1, 1:3 to 3:1, or from (0.80-1):2 to 2:1, or from (1-1.3):(1-1.3), or from (1-1,25):(1-1.25).

In one aspect, the catalyst system utilized in the process(es) of the invention comprises tin atoms in any amount, optionally, as the primary catalyst system.

In one aspect, examples of tin catalysts useful in the present invention include, but are not limited to, one of more of the following: monobutyltin tris-2-ethylhexanoate, dibutyltin diacetate, dibutyltin oxide, and dimethyl tin oxide.
In one aspect, the catalyst system utilized in the process(es) of the invention comprises at least one tin compound as the primary catalyst system, wherein the total catalyst metal atoms present in the final polyester is in the range of from 50 to 300 ppm, or from 50 to 250 ppm, or from 50 to 200 ppm, or from 50 to 175 ppm, or from 50 to 170 ppm, or from 75 to 300 ppm, or from 75 to 250 ppm, or from 75 to 200 ppm, or from 75 to 175 ppm, or from 75 to 170 ppm, or from 100 to 300 ppm, or from 100 to 250 ppm, or from 100 to 200, or from 100 to 175 ppm, or from 100 to 170 ppm, or from 110 to 300 ppm, or from 110 to 250 ppm, or from 110 to 200, or from 110 to 180, or from 110 to 175 ppm, or from 110 to 170 ppm, or from 120 to 300 ppm, or from 120 to 250 ppm, or from 120 to 200, or from 120 to 180, or from 120 to 175 ppm, or from 120 to 170 ppm, or from 125 to 300 ppm, or from 125 to 250 ppm, or from 125 to 200, or from 125 to 180, or from 125 to 175 ppm, or from 125 to 170 ppm, relative to the mass of final polyester being prepared.

In one aspect, the total percentage yield of TMCD residues in the process(es) of the invention can be at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues are used as compared to when 55/45 mole % cis/trans-TMCD is used for each catalyst system.

In one aspect, the total percentage yield of TMCD residues in the process(es) of the invention using a non-tin containing catalyst system is at least 3.5% or greater, or 3.0% or greater, or at least 2.5% or greater, or at least 2.0% or greater, or at least 1.5% or greater, or at least 1.4% or greater, or at least 1.3% or greater, or at least 1.2% or greater, or at least 1.0% or greater, when high cis-TMCD are used as compared to where 95/5 mole % cis/trans-TMCD is used in combination with a tin catalyst system.

In one aspect, the catalyst system utilized in the process(es) of the invention comprises lithium and aluminum, wherein the improvement in TMCD % yield at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues are used as compared to when 55/45 mole % cis/trans-TMCD is used with a tin catalyst system.

In one aspect, the catalyst system utilized in the process(es) of the invention comprises lithium and aluminum, wherein the improvement in TMCD % yield is 2 or more times, or 1.5 more times the % yield TMCD, as compared to when tin is used as the catalyst system and when each process employs 95/5 mole % cis/trans-TMCD.

In one aspect, the catalyst system utilized in the process(es) of the invention comprises lithium and aluminum, wherein the improvement in TMCD % yield is 2 or more times, or 1.5 more times the °./0 yield, when high cis-TMCD residues is compared to when 55/45 mole % cis/trans-TMCD is used with a tin catalyst system.

In one aspect, the catalyst system utilized in the process(es) of the invention comprises at least one titanium source and at least one zinc source; wherein the total percentage yield of TMCD residues is at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues are used as compared to when 55/45 mole % cis/trans-TMCD is used with a tin catalyst system.

In one aspect, the catalyst system utilized in the process(es) of the invention comprises at least one titanium source and at least one zinc source; wherein the improvement in TMCD % yield is 2.5 or more times, or 2 or more times, or 1.5 more times the % yield of TMCD, when high cis-TMCD residues are used as compared to when tin is the catalyst system and 95/5 mole % cis/trans-TMCD is used.

In one aspect, the polyesters and/or polyester compositions of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole %, or about 15 to about mole % of TMCD residues;
      (ii) about 50 to about 90 mole %, or about 60 to about mole % residues of CHDM;
wherein the total mole % of the dicarboxylic acid component is 100 mole %,
wherein the total mole % of the diol component is 100 mole %; and
(2) residues of a catalyst system comprising: (a) lithium atoms and aluminum atoms; or (b) titanium atoms and zinc atoms, wherein for (2)(a) and for (2)(b), tin atoms can optionally be present in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared; and wherein for (2)(b), titanium atoms can be present in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared;
wherein the inherent viscosity of the polyester and/or polyester composition is from 0.35 to 1.2 dL/g, or from 0.45 to 0.80 dL/g, or from 0.50 to 0.80 dL/g, or from 0.55 to 0.80 dL/g, or from 0.45 to 0.75 dL/g, or from 0.50 to 0.75 dL/g, or from 0.55 to 075 dL/g as determined in 60/40 (wt/wt) phenol/tetrachloroethane at a concentration of 0.5 g/100 ml at 25° C.;
wherein the b* value of the polyester and/or polyester composition is from 1 to 20, or from 1 to 15, or from 1 to 14, or from 1 to 13, or from 1 to 12, or from 1 to 11, or from 1 to 10, or from 1 to 9, or from 1 to 8, from 1 to 7, or from 1 to 6, or from 1 to 5, or less than 20, or less than 15, or less than 14, or less than 13, or less than 12, or less than 11, or less than 10, or less than 9, or less than 8, or less than 7, or less than 6, or less than 5, or less than 4, or less than 3, as determined by the L*a*b* color system of the CIE (International Commission on Illumination); and
wherein the L* value of the polyester and/or polyester composition is from 50 to 99, or from 50 to 90, or from 60 to 99, or from 60 to 90, or from to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 70 to 80, or from 75 to 95, or from 75 to 90, or from 75 to 85, or from 80 to 90, as determined by the L*a*b* color system of the CIE (International Commission on Illumination).

In one aspect, the polyesters and/or polyester compositions of the invention can have an inherent viscosity of from 0.35 to 1.2 dL/g, or from 0.35 to 0.80 dL/g, or from 0.35 to 0.75 dL/g, or from 0.50 to 1.2 dL/g, or from 0.50 to 0.80 dL/g, or from 0.50 to 0.75 dL/g, or from 0.50 to 0.70 dL/g, or from 0.50 to 0.65 dL/g, or from 0.50 to 0.60 dL/g, or from 0.55 to 0.75 dL/g, or from 0.55 to 0.70 dL/g, or from 0.60 to 0.75 dL/g, or from 0.60 to 0.70 dL/g, as determined in 60/40 (wt/wt) phenol/tetrachloroethane at a concentration of 0.5 g/100 ml at 25° C.

In one aspect, the polyesters and/or polyester compositions of the invention can have a Tg of from 85 to 130° C., or from 100 to 130° C., or from 100 to 125° C., or from 100 to 120° C.

In one aspect, the catalyst system utilized in the process(es) of the invention and/or the polyesters of the invention and/or polyester compositions of the invention can comprise tin atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one aspect, the catalyst system utilized in the process(es) of the invention can comprise titanium atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one aspect, the catalyst system utilized in the process(es) of the invention can comprise manganese atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one aspect, the catalyst system utilized in the process(es) of the invention can comprise zinc atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one aspect, the catalyst system utilized in the process(es) of the invention can comprise germanium atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one aspect, the polyesters and/or polyester compositions of the invention can comprise less than 10 ppm, or less than 5 ppm, or less than 2 ppm, or 0 ppm of titanium atoms, tin atoms, and/or manganese atoms.

In one aspect, the polyesters and/or polyester compositions of the invention can comprise less than 10 ppm, or less than 5 ppm, or less than 2 ppm, or 0 ppm of titanium atoms, tin atoms, and/or zinc atoms.

In one aspect, the polyesters and/or polyester compositions of the invention can comprise less than 10 ppm, or less than 5 ppm, or less than 2 ppm, or 0 ppm of titanium atoms, tin atoms, manganese atoms and/or zinc atoms.

In one aspect, the polyesters and/or polyester compositions of the invention can have a number average molecular weight of from 4,800 to 16,000.

In one aspect, the polyesters and/or polyester compositions of the invention can have a b* value of from −10 to less than 20, or from −10 to less than 10, or from 1 to less than 20, or from 5 to less than 20, or from 8 to less than 20, or from −3 to 10, or from −5 to 5, or from −5 to 4, or from −5 to 3, or from 1 to 10, or from 1 to 9, or from 1 to 8, from 1 to 7, or from 1 to 6, or from 1 to 5, or less than 20, or less than 15, or less than 14, or less than 13, or less than 12, or less than 11, or less than 10, or less than 9, or less than 8.5, or less than 8, or less than 7, or less than 6, or less than 5, or less than 4, or less than 3, or from 1 to 10, or from 1 to 9, or from 1 to 8, or from 1 to 7, or from 1 to 6, or from 1 to 5, or from 2 to 6, as determined by the L*a*b* color system of the CIE (International Commission on Illumination).

In one aspect, the polyesters and/or polyester compositions of the invention can have a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 75 to 85, or from 70 to 80, or from 75 to 95, or from 75 to 90, or from 75 to 85, or from 80 to 90, as determined by the L*a*b* color system of the CIE (International Commission on Illumination).

In one aspect, the b* and/or L* and/or a*values can be obtained in the presence of and/or in the absence of toner(s).

In one aspect, the polyesters and/or polyester compositions of the invention can comprise residues of at least one branching agent in the amount of 0.01 to 10 mole %, or 0.01 to 5 mole %, based on the total mole percentage of the diacid or diol residues.

In one aspect, the polyesters and/or polyester compositions of the invention can have a melt viscosity less than 30,000, or less than 20,000, or less than 12,000, or less than 10,000, or less than 7,000, or less than 5,000 poise, or less than 3,000 poise, as measured at 1 radian/second on a rotary melt rheometer at 290° C.

In one aspect, the polyesters and/or polyester compositions of the invention can have a notched Izod impact strength of at least 1 ft-lbs/inch, or at least 2 ft-lbs/inch, or at least 3 ft-lbs/inch, or at least 7.5 ft-lbs/in, or at least 10 ft-lbs/in at 23° C. according to ASTM D256 with a 10-mil notch in a ⅛-inch thick bar.

In one aspect, the polyesters and/or polyesters compositions can have a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

In one aspect, the polyesters compositions can comprise at least one polyester useful in the invention blended with at least one polymer chosen from at least one of the following: other polyesters (such as polyethylene terephthalate (PET), including recycled PET, poly(cyclohexylene) terephthalate (e.g., PCT), modified PET or PET modified with 1,4-cycllohexanedimethanol CHDM (e.g., PETG), poly(etherimides), polyphenylene oxides, poly(phenylene oxide)/polystyrene blends, polystyrene resins, polyphenylene sulfides, polyphenylene sulfide/sulfones, poly(ester-carbonates), polycarbonates, polysulfones; polysulfone ethers, and poly(ether-ketones).

In one aspect, the polyester compositions of the invention can comprise at least one polycarbonate, or no polycarbonate, or no carbonate groups.

In one aspect, the polyester compositions of the invention may or may not contain residues of a crosslinking agent.

In one aspect, the polyester compositions of the invention can comprise residues of at least one phosphorus compound.

In one aspect, the polyester compositions of the invention can comprise residues of phosphoric acid, phosphorous acid, phosphonic acid, phosphinic acid, phosphonous acid, and/or various esters and/or salts thereof. These esters can be alkyl, branched alkyl, substituted alkyl, difunctional alkyl, alkyl ethers, aryl, and substituted aryl.

In one aspect, the polyester compositions of the invention can comprise at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and/or mixtures thereof.

In one aspect, the polyester compositions of the invention can comprise at least one of substituted or unsubstituted alkyl phosphate esters, substituted or unsubstituted aryl phosphate esters, mixed substituted or unsubstituted alkyl aryl phosphate esters, reaction products thereof, and mixtures thereof.

In one aspect, the polyester compositions of the invention can comprise no phosphorus compound.

In one aspect, the polyesters and/or polyester compositions of the invention can be blended with recycled poly(ethylene terephthalate) (rPET).

In one aspect, the polyesters and/or polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, containers, and/or bottles (for example, baby bottles or sports bottles or water bottles).

In one aspect, there is provided a process for making any of the polyesters and/or polyester compositions of the invention comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) 70 to 100 mole % of terephthalic acid residues;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms; and
   (b) a glycol component comprising:
      (i) 10 to 50 mole % of cis-TMCD residues in the amount of 90 mole % or greater; and trans-TMCD residues in the amount of 10 mole % or less; and
      (ii) 50 to 90 mole % of CHDM residues;
wherein the molar ratio of glycol component/dicarboxylic acid component added in Step (I) is 1.0-1.5/1.0;
(II) heating the product of Step (I) at a temperature of 230° C. to 320° C. for 1 to 6 hours under at least one pressure chosen from the range of the final pressure of Step (I) to 0.02 torr absolute;
wherein the mixture in Steps (I) or (II), respectively, when heated, is heated in the presence of at least one catalyst system comprising: at least one aluminum compound and at least one lithium compound; or at least one titanium compound and at least one zinc compound; and
wherein the final product after Step (II) comprises either: lithium atoms and aluminum atoms; or titanium atoms and zinc atoms;
wherein the total mole % of the dicarboxylic acid component of the final polyester is 100 mole %;
wherein the total mole % of the glycol component of the final polyester is 100 mole %;
wherein the inherent viscosity of the final polyester is from 0.35 to 1.2 dL/g as determined in 60/40 (wt/wt) phenol/tetrachloroethane at a concentration of 0.25 g/50 ml at 25° C.; and
wherein the final polyester has a Tg from 85° C. to 150° C.

In one aspect, the process above is provided except that the lithium source is added in Step (I) and the source of said aluminum source is added in Step (II).

In one aspect, the process above is provided except that the titanium source is added in Step (I) and the source of said zinc source is added in Step (II).

In one aspect, the extent of TMCD incorporation or conversion in the final polymer can be greater than 55 mole %; or greater than 50 mole %; or greater than 45 mole %; or 45 mole % or greater; greater than 40 mole %; or greater than 35 mole %; or greater than 30 mole %.

In one aspect, the processes of making the polyesters useful in the invention can comprise a batch or continuous process.

In one aspect, the processes of making the polyesters useful in the invention comprise a continuous process.

In one aspect, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % TMCD residues; and
      (ii) about 50 to about 90 mole % of CHDM residues;
wherein the molar ratio of glycol component/dicarboxylic acid component added in Step (I) is 1.01-3.0/1.0 and wherein TMCD is added in an amount from about 10 to 50 mole %, to arrive at a final polymer having about 10 to 50 mole % TMCD residues;
wherein the mixture in Step (I) is heated in the presence of: (i) a catalyst system comprising either: lithium atoms and aluminum atoms; or titanium atoms and zinc atoms; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %; and wherein the total mole % of the glycol component of the final polyester is 100 mole %;
wherein the inherent viscosity of the polyester is from 0.50 to 0.80 dL/g as determined in 60/40 (wt/wt) phenol/tetrachloroethane at a concentration of 0.25 g/50 ml at 25° C.; and wherein the L* color values for the polyester is 75 or greater, as determined by the L*a*b* color system of the CIE (International Commission on Illumination).

In one aspect, the above-described catalyst system utilized in the process(es) of the invention comprises lithium atoms and aluminum atoms.

In one aspect, the above-described catalyst system utilized in the process(es) of the invention comprises titanium atoms and zinc atoms.

In certain aspects of the invention, the above-described catalyst system comprises no tin, and/or no titanium.

In one aspect, certain polyesters of the invention can be amorphous or semicrystalline. In one aspect, certain of the polyesters of the invention can have a relatively low crystallinity. Certain polyesters of the invention can thus have a substantially amorphous morphology, meaning that the polyesters comprise substantially unordered regions of polymer.

In one aspect, the pressure used in Step (I) of any of the processes of the invention can consist of at least one pressure chosen from 0 psig to 75 psig. In one aspect, the pressure used in Step (I) of any of the processes of the invention consists of at least one pressure chosen from 0 psig to 50 psig.

In one aspect, the pressure used in Step (II) of any of the processes of the invention can consist of at least one pressure chosen from 20 torr absolute to 0.02 torr absolute; aspect, the pressure used in Step (II) of any of the processes of the invention can consist of at least one pressure chosen from 10 torr absolute to 0.02 torr absolute; aspect, the pressure used in Step (II) of any of the processes of the invention can consist of at least one pressure chosen from 5 torr absolute to 0.02 torr absolute; aspect, the pressure used in Step (II) of any of the processes of the invention can consist of at least one pressure chosen from 3 torr absolute to 0.02 torr absolute; aspect, the pressure used in Step (II) of any of the processes of the invention can consist of at least one pressure chosen from 20 torr absolute to 0.1 torr absolute; aspect, the pressure used in Step (II) of any of the processes of the invention can consist of at least one pressure chosen from 10 torr absolute to torr absolute; aspect, the pressure used in Step (II) of any of the processes of the invention can consist of at least one pressure chosen from 5 torr absolute to 0.1 torr absolute; aspect, the pressure used in Step (II) of any of the processes of the invention can consist of at least one pressure chosen from 3 torr absolute to 0.1 torr absolute.

In one aspect, the molar ratio of glycol component/dicarboxylic acid component added in Step (I) of any of the processes of the invention is 1.0-3.0/1.0; in one aspect, the molar ratio of glycol component/dicarboxylic acid component added in Step (I) of any of the processes of the invention is 1.0-2.5/1.0; in one aspect, the molar ratio of glycol component/dicarboxylic acid component added in Step (I) of any of the processes of the invention is 1.0-2.0/1.0; in one aspect, the molar ratio of glycol component/dicarboxylic acid component added in Step (I) of any of the processes of the invention is 1.0-1.75/1.0; in one aspect, the molar ratio of glycol component/dicarboxylic acid component added in Step (I) of any of the processes of the invention is 1.0-1.5/1.0.

In any of the process embodiments for making the polyesters useful in the invention, the heating time of Step (II) may be from 1 to 5 hours. In any of the process embodiments for making the polyesters useful in the invention, the heating time of Step (II) may be from 1 to 4 hours. In any of the process embodiments for making the polyesters useful in the invention, the heating time of Step (II) may be from 1 to 3 hours. In any of the process embodiments for making the polyesters useful in the invention, the heating time of Step (II) may be from 1.5 to 3 hours. In any of the process embodiments for making the polyesters useful in the invention, the heating time of Step (II) may be from 1 to 2 hours.

The weight of aluminum atoms and lithium atoms, e.g., ppm, present in the final polyester can be measured and can be in any of the aforesaid weight ratios, for example.

In one aspect, the polyesters and/or polyester compositions of the invention, can be useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one aspect, the polyesters and/or polyester compositions of the invention can be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In one aspect, the invention relates to thermoformed film(s) and/or sheet(s) comprising the polyester(s) and/or polyester compositions.

In one aspect, the invention relates to articles of manufacture which incorporate the thermoformed film and/or sheet of the invention.

In one aspect, the invention provides a process for preparing polyesters and/or polyester compositions containing TMCD and CHDM residues with improved color and/or clarity and/or improved TMCD yield.

In one aspect, any of the polyesters and/or polyester compositions described herein are also considered within the scope of this invention, regardless of which process is used to make them, and any products made therefrom.

In one aspect, the invention is related to articles of manufacture, e.g., shaped articles, that comprise any of the polyesters and/or polyester compositions of the invention.

In one aspect, any of the processes of making the polyesters useful in the invention and described herein or known by one of ordinary skill in the art may be used to make any of the polyesters and/or polyester compositions of the invention.

### DETAILED DESCRIPTION OF THE INVENTION

The present invention may be understood more readily by reference to the following detailed description of certain embodiments of the invention and the working examples. In accordance with the purpose(s) of this invention, certain embodiments of the invention are described in the Summary of the Invention and are further described herein below. Also, other embodiments of the invention are described herein.

It is believed that certain polyesters and/or polyester composition(s) of the invention can be formed from terephthalic acid or ester(s) thereof, and/or combinations thereof, TMCD and CHDM residues, further comprising certain catalyst systems and, optionally, comprising stabilizers, reaction products thereof, and mixtures thereof, can have a unique combination of two or more, or three or more of the following properties: good notched Izod impact strength, good inherent viscosities, good glass transition temperature (Tg), good flexural modulus, good tensile strength, good clarity, good color, good dish washer durability, good TMCD incorporation, good/improved TMCD yield, and good/improved melt stability.

In one embodiment, this invention relates to polyesters, polyester compositions, and/or processes of making polyesters and/or polyester compositions comprising residues of CHDM and high cis-TMCD.

In one embodiment, this invention relates to a polyester composition comprising at least one polyester further comprising:
(a) a dicarboxylic acid component comprising:
   (i) 70 to 100 mole % of residues of terephthalic acid and/or at least one ester thereof;
   (ii) 0 to 30 mole % of aromatic dicarboxylic acid residues having up to 20 carbon atoms; and
   (iii) 0 to 10 mole % of aliphatic dicarboxylic acid residues having up to 16 carbon atoms;
(b) a glycol component comprising:
   (i) 10 to 50 mole % of 2,2,4,4-tetramethyl-1,3-cyclobutanediol residues, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol;
   (ii) 50 to 90 mole % of cyclohexanedimethanol residues; and
   (iii) optionally, residues of at least one modifying glycol;
wherein the total mole % of the dicarboxylic acid component of the final polyester is 100 mole %;
wherein the total mole % of the glycol component of the final polyester is 100 mole %; and
wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one embodiment, this invention relates to a process for preparing a polyester composition comprising at least one polyester further comprising:
(a) a dicarboxylic acid component comprising:
   (i) 70 to 100 mole % of residues of terephthalic acid and/or at least one ester thereof;
   (ii) 0 to 30 mole % of aromatic dicarboxylic acid residues having up to 20 carbon atoms; and
   (iii) 0 to 10 mole % of aliphatic dicarboxylic acid residues having up to 16 carbon atoms;
(b) a glycol component comprising:
   (i) 10 to 50 mole % of 2,2,4,4-tetramethyl-1,3-cyclobutanediol residues, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol;
   (ii) 50 to 90 mole % of cyclohexanedimethanol residues; and
   (iii) optionally, residues of at least one modifying glycol;
wherein the total mole % of the dicarboxylic acid component of the final polyester is 100 mole %;
wherein the total mole % of the glycol component of the final polyester is 100 mole %; and
wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one embodiment, this invention relates to novel processes for making polyesters and/or polyester compositions comprising residues of CHDM and of high cis-TMCD and, optionally, using a catalyst system comprising: (a) lithium atoms and aluminum atoms; or (b) titanium and zinc atoms; or (c) tin atoms.

In one embodiment, this invention relates to novel processes for making polyesters and/or polyester compositions comprising residues of CHDM and of high cis-TMCD and using a catalyst system comprising redox inactive catalysts. Certain redox inactive catalyst systems can comprise: (a) lithium atoms and aluminum atoms; or (b) titanium and zinc atoms.

In one embodiment, copolyesters containing TMCD and CHDM residues over a range of compositions can be prepared with at least one lithium catalyst and at least one aluminum catalyst, or at least one titanium catalyst and at least one zinc catalyst.

The present invention relates to polyesters based on terephthalic acid or esters thereof, TMCD and at least one modifying glycol catalyzed by certain catalyst types and/or amounts that provide improved properties (as discussed herein), and in certain embodiments, at least one lithium catalyst and at least one aluminum catalyst, or at least one titanium catalyst and at least one zinc catalyst, resulting in good TMCD incorporation, good TMCD yield, improved color (higher brightness and/or less yellow), and reactivity to achieve desired inherent viscosity (IV) over the compositional range described herein, as well as other beneficial properties.

When lithium is added to the polyesters and/or polyester compositions and/or process of making the polyesters of the invention, it is added to the process of making the polyester in the form of a lithium compound. The amount of the lithium compound added to the polyesters of the invention and/or polyester compositions of the invention and/or processes of the invention can be measured in the form of lithium atoms present in the final polyester, for example, by weight measured in ppm.

When aluminum is added to the polyesters and/or polyester compositions and/or process of making the polyesters of the invention, it is added to the process of making the polyester in the form of an aluminum compound. The amount of the aluminum compound added to the polyesters of the invention and/or polyester compositions of the invention and/or processes of the invention can be measured in the form of aluminum atoms present in the final polyester, for example, by weight measured in ppm.

When titanium is added to the polyesters and/or polyester compositions and/or process of making the polyesters of the invention, it is added to the process of making the polyester in the form of a titanium compound. The amount of the titanium compound added to the polyesters of the invention and/or polyester compositions of the invention and/or processes of the invention can be measured in the form of titanium atoms present in the final polyester, for example, by weight measured in ppm.

When zinc is added to the polyesters and/or polyester compositions and/or process of making the polyesters of the invention, it is added to the process of making the polyester in the form of a zinc compound. The amount of the zinc compound added to the polyesters of the invention and/or polyester compositions of the invention and/or processes of the invention can be measured in the form of zinc atoms present in the final polyester, for example, by weight measured in ppm.

When phosphorus is added to the polyesters and/or polyester compositions and/or process of making the polyesters of the invention, it is added to the process of making the polyester in the form of a phosphorus compound. In one embodiment, this phosphorus compound can comprise at least one phosphate ester(s). The amount of phosphorus compound, [for example, phosphate ester(s)] added to the polyesters of the invention and/or polyester compositions of the invention and/or processes of the invention can be measured in the form of phosphorus atoms present in the final polyester, for example, by weight measured in ppm.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol such as, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid such as, for example, p-hydroxybenzoic acid, and the difunctional hydroxyl compound may be an aromatic nucleus bearing 2 hydroxyl substituents such as, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through a carbonyloxy group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make polyester.

The polyesters of the present invention typically can be prepared from dicarboxylic acids and diols which react in substantially equal proportions and are incorporated into the polyester polymer as their corresponding residues. The polyesters of the present invention, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % TMCD, based on the total diol residues, means the polyester contains mole % TMCD residues out of a total of 100 mole % diol residues. Thus, there are 25 moles of TMCD residues among every 100 moles.

In one embodiment of the invention, a process for making at least one polyester is provided comprising the following steps:
(I) heating a mixture of at least one temperature chosen from 150° C. to 300° C., under at least one pressure chosen from the range of 0 psig to 100 psig wherein said mixture comprises:
   (a) a dicarboxylic acid component comprising:
      (i) 70 to 100 mole % of terephthalic acid residues;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms;
   (b) a glycol component comprising:
      (i) 10 to 50 mole % of cis-TMCD residues in the amount of mole % or greater; and trans-TMCD residues in the amount of 10 mole % or less;
      (ii) 50 to 90 mole % of cyclohexanedimethanol residues; and
      (iii) optionally, residues of at least one modifying glycol;
   wherein the molar ratio of glycol component/dicarboxylic acid component added in Step (I) is 1.0-1.5/1.0;
(II) heating the product of Step (I) at a temperature of 230° C. to 320° C. for 1 to 6 hours, under at least one pressure chosen from the range of the final pressure of Step (I) to 0.02 torr absolute, to form a final polyester;
   wherein the total mole % of the dicarboxylic acid component of the final polyester is 100 mole %;
   wherein the total mole % of the glycol component of the final polyester is 100 mole %; and
   wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

In one embodiment, the mixture in Step (I) can be heated in the presence of at least one catalyst system comprising:
(i) at least one lithium compound and at least one aluminum compound; or
(ii) at least one titanium compound and at least one zinc compound; or
(iii) at least one tin compound.

In one embodiment, the mixture in Step (I) is heated in the presence of a first catalyst, and Step II is heated in the presence of a second catalyst, and wherein the catalyst system comprises one of the following:
(i) the first catalyst comprises at least one lithium compound and the second catalyst comprises at least one aluminum compound; or
(ii) the first catalyst comprises at least one titanium compound and a second catalyst comprising at least one zinc compound.

In one embodiment, the catalyst system utilized in the process(es) of the invention comprises lithium atoms and aluminum atoms. In one embodiment, tin atoms can be present hi an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared. Optionally, also, titanium atoms can be present in any amount, but also in amounts of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention comprises titanium atoms and zinc atoms. In one embodiment, tin atoms can be present in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention comprises tin atoms.

In one embodiment, the polyesters useful in the polyester compost ons of the invention can optionally comprise modifying glycol residues.

In one embodiment, at least one polyester of the invention can comprise at least one modifying glycol selected from diethylene glycol, 1,2-propanediol, 1,3-propanediol, 2-methyl-1,3-propanediol, ethylene glycol, 1,4-butanediol, 1,5-pentanediol, 1,6-hexanediol, p-xylene glycol, neopentyl glycol, isosorbide, polytetramethylene glycol, or mixtures thereof.

In one embodiment, at least one polyester of the invention can comprise residues of TMCD in the amount of from about 10 to about 45 mole, or from about 10 to about 40 mole %, or from about 10 to about 35 mole %, or from about 20 to about 45 mole, or from about 20 to about 40 mole %, or from about 20 to about 35 mole %, or from about 25 to about 45 mole, or from about 25 to about 40 mole %, or from about 30 to about 35 mole %.

In one embodiment, at least one polyester of the invention can comprise CHDM residues in the amount of from about 55 to about 90 mole/0, or from about 60 to about 90 mole %, or from about 65 to about 90 me %, or from about 55 to about 80 mole/0, or from about 60 to about 80 mole %, or from about 65 to about 80 mole %, or from about 60 to about 75 mole %, or from about 65 to about 70 mole %.

In one embodiment at least one polyester can comprise residues of TMCD in the amount of 20 to 45 mole % and residues of CHDM in the amount of 55 to 80 mole %, or residues of TMCD in the amount of 20 to 40 mole % and residues of CHDM in the amount of 60 to 80 mole %, or residues of TMCD in the amount of 20 to 35 mole % and residues of CHDM in the amount of 65 to 80 mole %, or 25 to 45 mole % and residues of CHDM in the amount of 55 to 75 mole %, or residues of TMCD in the amount of 25 to 40 mole % and residues of CHDM in the amount of 60 to 75 mole %, or residues of TMCD in the amount of 25 to 35 mole % and residues of CHDM in the amount of 65 to 75 mole %; or residues of TMCD in the amount of 30 to 35 mole % and residues of CHDM in the amount of 65 to 70 mole %.

In one embodiment, the polyesters can comprise TMCD residues which can be a combination of greater than 70 mole % of cis-TMCD and less than 30 mole % of trans-TMCD, or greater than 75 mole % of cis-TMCD and less than 25 mole % of trans-TMCD, or greater than 80 mole % of cis-TMCD and less than 20 mole % of trans-TMCD, or greater than 85 mole % of cis-TMCD and less than 15 mole % of trans-TMCD, or greater than 90 mole % of cis-TMCD and less than 10 mole % of trans-TMCD, or greater than 95 mole % of cis-TMCD and less than 5 mole % of trans-TMCD. Each of these ranges are embodied within the term used as described herein, “high cis-TMCD”, including but not limited to greater than 90 mole % of cis-TMCD and less than 10 mole % of trans-TMCD, or greater than 95 mole % of cis-TMCD and less than 5 mole % of trans-TMCD.

In one embodiment, the polyesters and/or polyester compositions made using the process(es) of the invention can comprise CHDM. In another embodiment, the polyesters useful in the invention comprise CHDM and 1,3-cyclohexanedimethanol. The molar ratio of cis/trans 1,4-cyclohexandimethanol can vary within the range of 50/50 to 0/100, for example, between 40/60 to 20/80.

In one embodiment, the polyesters and/or polyester compositions of the invention can have a molar ratio of TMCD:CHDM from 1:9 to 1:1, or from 1:4 to 1:1, or from or from 1:3 to 1:1.5, or from 1:3 to 1:1, or from 1:2 to 1:1, or from 1:1.5 to 1:1.

In one embodiment, the final polyesters and/or final polyester compositions of the invention can comprise residues of ethylene glycol or which can comprise no residues of ethylene glycol.

In one embodiment, the final polyesters and/or final polyester compositions of the invention can comprise less than less than 55 mole %, or less than 50 mole %, or less than 40 mole %, or less than 35 mole %, or less than 30 mole %, or less than 25 mole %, or less than 20 mole %, or less than 15 mole %, or less than 10 mole %, or 0 mole % of ethylene glycol residues.

In one embodiment, at least one polyester of the invention can comprise no hexanediol, and/or no propanediol, and/or no butanediol.

In certain embodiments of the invention, the polyesters of the invention can contain less than about 2 mole % of a modifying glycol having from 3 to 16 carbon atoms. In certain embodiments, the polyester contains no other added modifying glycols. It should be understood that some other glycol residues may be formed in situ during processing.

In one embodiment, the diacid component of at least one polyester of the invention can comprise aromatic and/or aliphatic dicarboxylic acid ester residues.

In certain embodiments, terephthalic acid or an ester thereof, such as, for example, dimethyl terephthalate or a mixture of terephthalic acid residues and an ester thereof can make up a portion or all of the dicarboxylic acid component used to form the polyesters useful in the invention. In certain embodiments, terephthalic acid residues can make up a portion or all of the dicarboxylic acid component used to form the polyesters useful in the invention. In certain embodiments, higher amounts of terephthalic acid can be used in order to produce a higher impact strength polyester. For purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present invention. In certain embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In one embodiment, terephthalic acid may be used as the starting material. In another embodiment, dimethyl terephthalate may be used as the starting material. In yet another embodiment, mixtures of terephthalic acid and dimethyl terephthalate may be used as the starting material and/or as an intermediate material.

In addition to terephthalic acid and/or ester(s) thereof, the dicarboxylic acid component of the polyesters useful in the invention can comprise up to 30 mole % of one or more modifying aromatic dicarboxylic acids. Thus, if present, it is contemplated that the amount of one or more modifying aromatic dicarboxylic acids can range from any of these preceding endpoint values including, for example, up to 30 mole %, or up to 20 mole %, or up to 10 mole %, or up to 5 mole %, or up to 1 mole %, or 0.01 to 10 mole %, or from 0.01 to 5 mole %, or from 0.01 to 1 mole %, or 0 mole %. In one embodiment, modifying aromatic dicarboxylic acids that may be used in the present invention include but are not limited to those having up to 20 carbon atoms, and which can be linear, para-oriented, or symmetrical. Examples of modifying aromatic dicarboxylic acids which may be used in this invention include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the invention can be further modified with up to 30 mole %, or up to 20 mole %, or up to 10 mole %, or up to 5 mole %, or up to 1 mole %, of one or more aliphatic dicarboxylic acids containing 2-16 carbon atoms, such as, for example, cyclohexanedicarboxylic, malonic, succinic, glutaric, adipic, pimelic, suberic, azelaic and dodecanedioic dicarboxylic acids, Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the invention.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, the diacid component of the polyesters of the invention can comprise from 0 to 30 mole %, or 0 to 20 mole %, or 0 to 10 mole % of aliphatic diacid residues, including but not limited to, 1,4-cyclohexanedicarboxylic acid (CHDA).

In one embodiment, the polyesters and/or polyester compositions of the invention can comprise CHDA, e.g., trans-CHDA, in an amount of less than 30 mole %, or less than 20 mole %, or less than 10 mole %, or less than 5 mole %, or from 0 to 30 mole %, or from 0 to 20 mole %, or from 0 to 10 mole %, or 0 mole, based on the total mole percentages of diacid residues in the final polyester equaling 100 mole %.

In one embodiment, the catalyst system utilized in the process(es) of the invention can comprise lithium atoms and aluminum atoms; or titanium atoms and zinc atoms; and optionally, tin atoms in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention can comprise lithium atoms and aluminum atoms; and optionally, tin atoms and/or titanium atoms with each in an amount of less than 30 ppm, or less than 20 ppm, or less than 10 ppm, or less than 5 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention comprises lithium atoms and aluminum atoms, wherein at least one lithium source can be selected from, but is not limited to, lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, or alkyl lithium, lithium aluminum hydride, lithium borohydride, lithium oxide.

In one embodiment, the catalyst system utilized in the process(es) of the invention comprises lithium atoms and aluminum atoms, wherein at least one lithium source is lithium acetylacetonate.

In one embodiment, the catalyst system utilized in the process(es) of the invention comprises lithium and aluminum, wherein at least one aluminum source can be selected from, but is not limited to, aluminum acetate, aluminum benzoate, aluminum sulfate, aluminum lactate, aluminum laurate, aluminum stearate, aluminum alcoholates, aluminum ethylate, aluminum isopropoxide, aluminum tri-butyrate, aluminum tri-cert-butyrate, mono-sec-butoxyaluminurn diisopropylate, and aluminum chelates, ethyl acetoacetate aluminum diisopropylate, aluminum tris(ethyl acetoacetate), alkyl acetoacetate, aluminum diisopropylate, aluminum monoacetylacetate bis(ethyl acetoacetate), aluminum tris(acetyl acetate), or aluminum acetylacetonate.

In one embodiment, the catalyst system utilized in the process(es) of the invention comprises lithium and aluminum, wherein at least one aluminum compound can be selected from, but is not limited to, aluminum hydroxide, aluminum acetylacetonate, aluminum acetate, aluminum isopropoxide, or aluminum sulfate.

In one embodiment, the catalyst system utilized in the process(es) of the invention comprises lithium and aluminum, wherein at least one aluminum compound can be selected from, but is not limited to, aluminum acetylacetonate and aluminum isopropoxide.

In one embodiment of the invention, the polyesters and/or polyester compositions of the invention can comprise lithium atoms and/or aluminum atoms in the amount of from 5 to 500 ppm, or from 5 to 450 ppm, or from 5 to 400 ppm, or 5 to 350 ppm, or 5 to 300 ppm, or from 5 to 250 ppm, or from 5 to 200 ppm, or from 5 to 150 ppm, or from 5 to 125 ppm, or from 5 to 100 ppm, or from 5 to 90 ppm, or from 5 to 85 ppm, or from 5 to 80 ppm, or from 5 to 75 ppm, or from 5 to 70 ppm, or from 5 to 65 ppm, or from 5 to 60 ppm, or 10 to 500 ppm, or from 10 to 450 ppm, or from 10 to 400 ppm, or 10 to 350 ppm, or from 10 to 300 ppm, or from 10 to 250 ppm, or from 10 to 200 ppm, or from 10 to 150 ppm, or from 10 to 125 ppm, or from 10 to 100 ppm, or from 10 to 90 ppm, or from 10 to 80 ppm, or from 10 to 75 ppm, or from 10 to 70 ppm, or from 10 to 65 ppm, or from 10 to 60 ppm, or from 25 to 500 ppm, or from 25 to 450 ppm, or from 25 to 400 ppm, or 25 to 350 ppm, or from 25 to 300 ppm, or from 25 to 250 ppm, or from 25 to 200 ppm, or from 25 to 150 ppm, or from 25 to 125 ppm, or from 25 to 100 ppm, or from 25 to 90 ppm, or from 25 to 80 ppm, or from 25 to 75 ppm, or from 25 to 70 ppm, or from 25 to 65 ppm, or from 25 to 60 ppm, or from 30 to 500 ppm, or from 30 to 450 ppm, or from 30 to 400 ppm, or 30 to 350 ppm, or from 30 to 300 ppm, or from 30 to 250 ppm, or from 30 to 200 ppm, or from 30 to 150 ppm, or from 30 to 100 ppm, or from 30 to 90 ppm, or from 30 to 80 ppm, or from 30 to 75 ppm, or from 30 to 70 ppm, or from 30 to 65 ppm, or from 30 to 60 ppm, or from 40 to 500 ppm, or from 40 to 450 ppm, or from 40 to 400 ppm, or 40 to 350 ppm, or from 40 to 300 ppm, or from 40 to 250 ppm, or from 40 to 200 ppm, or from 40 to 150 ppm, or from 40 to 100 ppm, or from 40 to 90 ppm, or from 40 to 80 ppm, or from 40 to 75 ppm, or from 40 to 70 ppm, or from 40 to 65 ppm, or from 40 to 60 ppm, or from 50 to 500 ppm, or from 50 to 450 ppm, or from 50 to 400 ppm, or 50 to 350 ppm, or from 50 to 300 ppm, or from 50 to 250 ppm, or from 50 to 200 ppm, or from 50 to 150 ppm, or from 50 to 100 ppm, or from to 90 ppm, or from 50 to 80 ppm, or from 50 to 75 ppm, or from 50 to 70 ppm, or from 50 to 65 ppm, or from 50 to 60 ppm, relative to the mass of final polyester being prepared.

In one embodiment, the amount of lithium atoms and/or aluminum atoms present in the polyesters and/or polyester compositions of the invention generally can range from at least 5 ppm, or at least 8 ppm, or at least 10 ppm, or at least 15 ppm, or at least 20 ppm, or at least 25 ppm, or at least 30 ppm, or at least 35 ppm, or at least 40 ppm, or at least 45 ppm, or at least 50 ppm, and less than 100 ppm, or less than 90 ppm, or less than 80 ppm, or less than 75 ppm, or less than 70 ppm, or less than 65 ppm, or less than 60 ppm, based on the total weight of the polymer.

In one embodiment, the catalyst system utilized in the invention comprises lithium atoms and/or aluminum atoms, wherein the lithium atoms are present in the final polyester in the amount of from 10 ppm to 100 ppm, or 20 ppm to 100 ppm, or 25 ppm to 100 ppm, or 30 ppm to 100 ppm, or 35 ppm to 100 ppm, or 40 ppm to 100 ppm, or 45 ppm to 100 ppm, or 50 ppm to 100 ppm, or 10 ppm to 75 ppm, or 15 ppm to 75 ppm, or 20 ppm to 75 ppm, or 25 ppm to 75 ppm, or 30 ppm to 75 ppm, or 35 ppm to 75 ppm, or 40 ppm to 75 ppm, or 45 ppm to 75 ppm, or 50 ppm to 75 ppm, or 10 ppm to 65 ppm, or 20 ppm to 65 ppm, or 30 ppm to 65 ppm, or 35 ppm to 65 ppm, or 40 ppm to 65 ppm, or 45 ppm to 65 ppm, or 50 ppm to 65 ppm, relative to the mass of final polyester being prepared.

In one embodiment, the catalyst system utilized in the invention comprises lithium atoms and/or aluminum atoms, wherein the total catalyst metal atoms of lithium and aluminum present in the final polyester is in the range of from 10 to 1000 ppm, or from 10 to 800 ppm, or from 10 to 600 ppm, or from 10 to 500 ppm, or from 10 to 400 ppm, or from 10 to 300 ppm, or from 10 to 250 ppm, or from 10 to 200 ppm, or from 10 to 150 ppm, or from 50 to 1000 ppm, or from 50 to 800 ppm, or from 50 to 600 ppm, or from 50 to 500 ppm, or from 50 to 400 ppm, or from 50 to 300 ppm, or from 50 to 250 ppm, or from 50 to 200 ppm, or from 50 to 150 ppm, or from 100 to 1000 ppm, or from 100 to 800 ppm, or from 100 to 600 ppm, or from 100 to 500 ppm, or from 100 to 400 ppm, or from 100 to 300 ppm, or from 100 to 250 ppm, or from 100 to 200 ppm, or from 200 to 1000 ppm, or from 200 to 800 ppm, or from 200 to 600 ppm, or from 200 to 500 ppm, or from 200 to 400 ppm, relative to the mass of final polyester being prepared.

In one embodiment, the catalyst system utilized in the invention comprises lithium atoms and aluminum atoms, wherein the ratio of lithium atoms to aluminum atoms as measured in ppm is from 1:5 to 5:1, or from 1:4 to 4:1, or from 1:3 to 3:1, or from 1:2 to 2:1; or from 1:1 relative to the mass of final polyester being prepared.

In one embodiment, the catalyst system utilized in the invention comprises titanium atoms and zinc atoms, wherein at least one titanium source can be selected from at least one of titanium carbonate, titanium acetate, titanium benzoate, titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide.

In one embodiment, the catalyst system utilized in the invention comprises titanium atoms and zinc atoms, wherein at least one titanium source can be selected from at least one of titanium dioxide, titanium isopropoxide, titanium acetylacetonate oxide, titanium bis(acetylacetonate)di-isopropoxide and/or combinations thereof.

In one embodiment, the catalyst system utilized in the invention comprises titanium atoms and zinc atoms, wherein at least one zinc source can be selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, dialkyl zinc, dimethyl zinc, diaryl zinc, zinc isopropoxide, zinc phosphate, and/or zinc acetylacetonate.

In one embodiment, the catalyst system utilized in the invention comprises titanium atoms and zinc atoms, wherein at least one titanium source can be selected from at least one of zinc acetylacetonate and zinc isopropoxide.

In one embodiment, the catalyst system utilized in the invention comprises titanium atoms and zinc atoms, wherein the zinc atoms present in the final polyester is in the range of from 50 to 1000 ppm, or from 50 to 750 ppm, or from 50 to 500 ppm, or from 50 to 300 ppm, or from 50 to 250 ppm, or from 50 to 200 ppm, or from 60 to 1000 ppm, or from 60 to 750 ppm, or from 60 to 500 ppm, or from 60 to 300 ppm, or from 60 to 250 ppm, or from 60 to 200 ppm, or from 75 to 1000 ppm, or from 75 to 750 ppm, or from 75 to 500 ppm, or from 75 to 300 ppm, or from 75 to 250 ppm, or from 75 to 200 ppm, or from 100 to 1000 ppm, or from 100 to 750 ppm, or from 100 to 500 ppm, or from 100 to 400 ppm, or from 100 to 300 ppm, or from 100 to 250 ppm, or from 100 to 200, or from 150 to 1000 ppm, or from 150 to 750 ppm, or from 150 to 500 ppm, or from 150 to 400 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 300 ppm, or from 200 to 250 ppm, relative to the mass of final polyester being prepared.

In one embodiment, the catalyst system utilized in the invention comprises titanium atoms and zinc atoms, wherein the total catalyst metal atoms present in the final polyester is in the range of from 150 to 800 ppm, or from 150 to 725 ppm, or from 150 to 700 ppm, or from 150 to 500 ppm, or from 150 to 450 ppm, or from 150 to 400 ppm, or from 150 to 300 ppm, 200 to 800 ppm, or from 200 to 725 ppm, or from 200 to 700 ppm, or from 200 to 600 ppm, or from 200 to 500 ppm, or from 200 to 450 ppm, or from 200 to 400 ppm, or from 200 to 300 ppm, or from 250 to 800 ppm, or from 250 to 725 ppm, or from 250 to 700 ppm, or from 250 to 500 ppm, or from 250 to 450 ppm, or from 250 to 400 ppm, or from 300 to 800 ppm, or from 300 to 725 ppm, or from 300 to 700 ppm, or from 300 to 500 ppm, or from 300 to 450 ppm, or from 300 to 400 ppm, or from 350 to 800 ppm, or from 350 to 725 ppm, or from 350 to 700 ppm, or from 350 to 500 ppm, or from 350 to 450 ppm, relative to the mass of final polyester being prepared.

In one embodiment, the catalyst system utilized in the invention comprises titanium atoms and zinc atoms, wherein the titanium atoms present in the final polyester is in the range of from 20 to 750 ppm, or from 20 to 500 ppm, or from 20 to 450 ppm, or from 20 to 400 ppm, or from 20 to 350 ppm, or from 20 to 300 ppm, or from 20 to 275 ppm, or from 20 to 250 ppm, or from 20 to 200 ppm, or from 50 to 1000 ppm, or from 50 to 750 ppm, or from 50 to 500 ppm, or from 50 to 450 ppm, or from 50 to 400 ppm, or from 50 to 300 ppm, or from 50 to 275 ppm, or from 50 to 250 ppm, or from 50 to 200 ppm, or from 60 to 1000 ppm, or from 60 to 750 ppm, or from 60 to 500 ppm, or from 60 to 450 ppm, or from 60 to 400 ppm, or from 60 to 350 ppm, or from 60 to 300 ppm, or from 60 to 275 ppm, or from 60 to 250 ppm, or from 60 to 200 ppm, or from 60 to 150 ppm, or from 60 to 100 ppm, or from 75 to 1000 ppm, or from 75 to 750 ppm, or from 75 to 500 ppm, or from 75 to 450 ppm, or from 75 to 400 ppm, or from 75 to 350 ppm, or from 75 to 300 ppm, or from 75 to 250 ppm, or from 75 to 200 ppm, or from 70 to 100 ppm, or from 70 to 90 ppm, or from 65 to 100 ppm, or from 65 to 90 ppm or from 80 to 1000 ppm, or from 80 to 750 ppm, or from 80 to 500 ppm, or from 80 to 450 ppm, or from 80 to 400 ppm, or from 80 to 350 ppm, or from 80 to 300 ppm, or from 80 to 275 ppm, or from 80 to 250 ppm, or from 80 to 200 ppm, or from 100 to 1000 ppm, or from 100 to 750 ppm, or from 100 to 500 ppm, or from 100 to 450 ppm, or from 100 to 400 ppm, or from 100 to 350 ppm, or from 100 to 300 ppm, or from 100 to 275 ppm, or from 100 to 250 ppm, or from 100 to 200, or from 150 to 1000 ppm, or from 150 to 750 ppm, or from 150 to 500 ppm, or from 150 to 450 ppm, or from 150 to 400 ppm, or from 150 to 350 ppm, or from 150 to 300 ppm, or from 150 to 250 ppm, or from 200 to 1000 ppm, or from 200 to 750 ppm, or from 200 to 500 ppm, or from 200 to 450 ppm, or from 200 to 400 ppm, or from 200 to 350 ppm, or from 200 to 300 ppm, or from 200 to 250 ppm, relative to the mass of final polyester being prepared.

In one embodiment, the catalyst system utilized in the invention comprises titanium atoms and zinc atoms, wherein the ratio of titanium atoms to zinc atoms in ppm relative to the mass of final polyester being prepared is from 0.50-1:5 to 5:1, or from 0.50-1:4 to 4:1, or from 0.50-1:3 to 3:1, or from to 1:5, or from 0.50-1 to 1:4, or from 0.60-1:5 to 5:1, or from 0.60-1:4 to 4:1, or from 0.60-1:3 to 3:1, or from 0.60:1 to 1:5, or from 0.60-1 to 1:4, or from 0.70-1:5 to 5:1, or from 0.70-1:4 to 4:1, or from 0.70-1:3 to 3:1, or from 0.70-1:2 to 2:1, or from 0.70-1.2 to 1:4, or from 0.75-1:5 to 5:1, or from 0.75-1.2 to 1:4 to 4:1, or from 075-1:3 to 3:1, or from 0.75-1:2 to 2:1, or from 0.75-1.0 to 1:4, or from 0.80:1.2 to 1:4, or from 1.0 to 1.5:1.0 to 1:7.1, or from 1.0 to 1.5:1.0 to 3, or from 1.0 to 1.5:1.0 to 2, or from 1.0 to 1.5:1.0 to 2.5, or from (0.80-1):5 to 5:1, or from (0.80-1):5 to 5:1, or from (0.80-1.2):4 to 4:1, 1:4 to 4:1, or from (0.80-1):3 to 3:1, 1:3 to 3:1, or from (0.80-1):2 to 2:1, or from (1-1.3):(1-1.3), or from (1-1.25):(1-1.25).

In one embodiment, the catalyst system utilized in the invention comprises tin atoms in any amount, optionally, as the primary catalyst system.

In one embodiment, the catalyst system utilized in the invention comprises at least one tin compound as the primary catalyst system, wherein the total catalyst metal atoms present in the final polyester is in the range of from 50 to 300 ppm, or from 50 to 250 ppm, or from 50 to 200 ppm, or from 50 to 175 ppm, or from 50 to 170 ppm, or from 75 to 300 ppm, or from 75 to 250 ppm, or from 75 to 200 ppm, or from 75 to 175 ppm, or from 75 to 170 ppm, or from 100 to 300 ppm, or from 100 to 250 ppm, or from 100 to 200, or from 100 to 175 ppm, or from 100 to 170 ppm, or from 110 to 300 ppm, or from 110 to 250 ppm, or from 110 to 200, or from 110 to 180, or from 110 to 175 ppm, or from 110 to 170 ppm, or from 120 to 300 ppm, or from 120 to 250 ppm, or from 120 to 200, or from 120 to 180, or from 120 to 175 ppm, or from 120 to 170 ppm, or from 125 to 300 ppm, or from 125 to 250 ppm, or from 125 to 200, or from 125 to 180, or from 125 to 175 ppm, or from 125 to 170 ppm, relative to the mass of final polyester being prepared.

In certain embodiments, tin sources can be present in the catalyst systems of the invention, for example, see U.S. Pat. No. 2,720,507, where the portion concerning tin catalysts is incorporated herein by reference. These catalysts are tin compounds containing at least one organic radical. These catalysts include compounds of both divalent or tetravalent tin which have the general formulas set forth below:

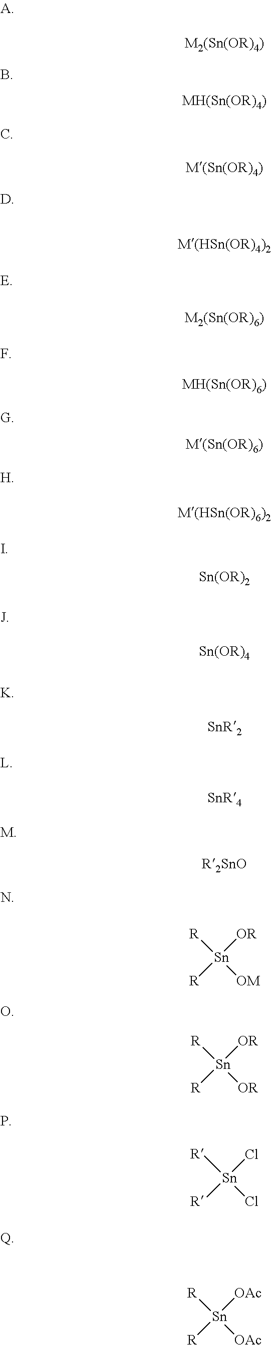

The novel bimetallic alkoxide catalysts can be made as described by Meerwein, Ann. 476, 113 (1929). As shown by Meerwein, these catalysts are not merely mixtures of the two metallic alkoxides, They are definite compounds having a salt-like structure. These are the compounds depicted above by the Formulas A through H. Those not specifically described by Meerwein can be prepared by procedures analogous to the working examples and methods set forth by Meerwein.

The other tin compounds can also be made by various methods such as those described in the following literature: For the preparation of diaryl tin dihalides (Formula P) see Ber. 62, 996 (1929); J. Am. Chem. Soc. 49, 1369 (1927). For the preparation of dialkyl tin dihalides (Formula P) see J. Am. Chem. Soc. 47, 2568 (1925); C.A. 41, 90 (1947). For the preparation of diaryl tin oxides (Formula M), see J. Am. Chem. Soc. 48, 1054 (1926). For the preparation of tetraaryl tin compounds (Formula K) see C.A. 32, 5387 (1938). For the preparation of tin alkoxides (Formula J) see C.A. 24, 586 (1930). For the preparation of alkyl tin salts (Formula 0) see C.A. 31, 4290. For the preparation of alkyl tin compounds (Formula K and L), see C.A. 35,2470 (1941), C.A. 33, 5357 (1939).

For the preparation of mixed alkyl aryl tin (Formulas K and L) see C.A, 31, 4290 (1937): C.A. 38, 331 (1944). For the preparation of other tin compounds not covered by these citations see “Die Chemie der Metal Organischen Verbindungen.” by Krause and V, Grosse, published in Berlin, 1937, by Gebroder-Bomtrager. The tin alkoxides (Formulas land J) and the bimetallic alkoxides (Formulas A through H) contain R substituents which can represent both straight chain and branched chain alkyl radicals, e.g. diethoxide, tetramethoxide, tetrabutoxide, tetra-tert-butoxide tetrahexoxide, etc.

The alkyl derivatives (Formulas K and L) contain one or more alkyl radicals attached to a tin atom through a direct C—Sn linkage, e.g. dibutyl tin, dihexyl tin, tetra-butyltin, tetraethyl tin, tetramethyl tin, dioctyl tin, etc. Two of the tetraalkyl radicals can be replaced with an oxygen atom to form compounds having Formula M, e.g. dimethyl tin oxide, diethyl tin oxide, dibutyl tin oxide, diheptyl tin oxide, etc. In one embodiment, the tin catalyst comprises dimethyl tin oxide.

Complexes can be formed by reacting dialkyl tin oxides with alkali metal alkoxides in an alcohol solution to form compounds having Formula N, which compounds are especially useful catalysts, e.g. react dibutyl tin oxide with sodium ethoxide, etc. This formula is intended to represent the reaction products described. Tin compounds containing alkyl and alkoxy radicals are also useful catalysts (see Formula O), e.g. diethyl tin diethoxide, dibutyl tin dibutoxide, dihexyl tin dimethoxide, etc.

Salts derived from dialkyl tin oxides reacted with carboxylic acids or hydrochloric acid are also of particular value as catalysts; see Formulas P and Q, Examples of these catalytic condensing agents include dibutyl tin diacetate, diethyl tin dibutyrate, dibutyl tin dilauroate, dimethyl tin dibenzoate, dibutyl tin dichloride, diethyl tin dichloride, dioctyl tin dichloride, dihexyl tin distearate, etc.

The tin compounds having Formulas K, L and M can be prepared wherein one or more of the R′ radicals represents an aryl radical of the benzene series, e.g. phenyl, tolyl, benzyl, etc. Examples include diphenyltin, tetraphenyl tin, diphenyl dibutyl tin, ditolyl diethyl tin, diphenyl tin oxide, dibenzyl tin, tetrabenzyl tin, di(β-phenylethyl) tin oxide, dibenzyl tin oxide, etc.

In one embodiment, catalysts useful in the present invention include, but are not limited to, one or more of the following: monobutyltin tris-2-ethylhexanoate, dibutyltin diacetate, dibutyltin oxide, and dimethyl tin oxide. Processes for preparing polyesters using tin-based catalysts are well known and described in the aforementioned U.S. Pat. No. 2,720,507.

In one embodiment, examples of tin catalysts useful in the present invention include, but are not limited to, one of more of the following: monobutyltin tris-2-ethylhexanoate, dibutyltin diacetate, dibutyltin oxide, and dimethyl tin oxide.

In one embodiment, the total percentage yield of TMCD residues in the process(es) of the invention can be at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues (90 mole % cis-TMCD or greater; or 95 mole % cis-TMCD or greater) are used as compared to when mole % cis/trans-TMCD is used for each catalyst system.

In one embodiment, the total percentage yield of TMCD residues in the process(es) of the invention using a non-tin containing catalyst system is at least 3.5% or greater, or 3.0% or greater, or at least 2.5% or greater, or at least 2.0% or greater, or at least 1.5% or greater, or at least 1.4% or greater, or at least 1.3% or greater, or at least 1.2% or greater, or at least 1.0% or greater, when high cis-TMCD residues (90 mole % cis-TMCD or greater; or 95 mole % or greater) are used as compared to where 95/5 mole % cis/trans-TMCD is used with a tin catalyst system.

In one embodiment, the catalyst system utilized in the process(es) of the invention comprises lithium and aluminum, wherein the improvement in TMCD % yield at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues (90 mole % cis-TMCD or greater; or 95 mole % or greater) are used as compared to when 55/45 mole % cis/trans-TMCD is used with a tin catalyst system.

In one embodiment, the catalyst system utilized in the process(es) of the invention comprises lithium and aluminum, wherein the improvement in TMCD % yield is 2 or more times, or 1.5 more times the % yield TMCD, as compared to when tin is the catalyst system, wherein each process uses 95/5 mole % cis/trans-TMCD.

In one embodiment, the catalyst system utilized in the process(es) of the invention comprises lithium and aluminum, wherein the improvement in TMCD % yield is 2 or more times, or 1.5 more times the % yield, when high cis-TMCD residues (90 mole % cis-TMCD or greater; or 95 mole % or greater) are used as compared to when 55/45 mole % cis/trans-TMCD is used with a tin catalyst system.

In one embodiment, the catalyst system utilized in the process(es) of the invention comprises at least one titanium source and at least one zinc source; wherein the total percentage yield of TMCD residues is at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater, when high cis-TMCD residues (90 mole % cis-TMCD or greater; or 95 mole % or greater) are used as compared to when 55/45 mole % cis/trans-TMCD is used with a tin catalyst system.

In one embodiment, the catalyst system utilized in the process(es) of the invention comprises at least one titanium source and at least one zinc source; wherein the improvement in TMCD % yield is 2.5 or more times, or 2 or more times, or 1.5 more times the % yield of TMCD, when high cis-TMCD residues (90 mole % cis-TMCD or greater; or 95 mole % or greater) are used as compared to when tin is used as the catalyst system with 95/5 mole % cis/trans-TMCD is used.

In one embodiment, any of the polyesters and/or polyester compositions described herein are also considered within the scope of this invention, regardless of which process is used to make them, and any products made therefrom.

In one embodiment, the invention is related to articles of manufacture, e.g., shaped articles, that comprise any of the polyesters and/or polyester compositions of the invention.

In one embodiment, any of the processes of making the polyesters useful in the invention and described herein or known by one of ordinary skill in the art may be used to make any of the polyesters and/or polyester compositions of the invention.

In one embodiment, the polyesters and/or the polyester compositions made by the process(es) of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole %, or about 15 to about mole % of TMCD residues;
      (ii) about 50 to about 90 mole %, or about 60 to about mole % residues of CHDM;
wherein the total mole % of the dicarboxylic acid component is 100 mole %,
wherein the total mole % of the diol component is 100 mole %; and
(2) residues of a catalyst system comprising lithium atoms and aluminum atoms; and optionally, less than 30 ppm, or less than 20 ppm, or less than 10 ppm, or less than 5 ppm, or from 0 to 30 ppm, or from 0 to 20 ppm, or from 0 to 10 ppm, or 0 ppm, of titanium atoms and/or tin atoms;
wherein the inherent viscosity is from 0.55 to 0.75 dL/g as determined in 60/40 (wt/wt) phenol/tetrachloroethane at a concentration of 0.5 g/100 ml at 25° C.; and having a b* value of less than 10, or of less than 9, or of less than 8, or of less than 7, or of less than 6, or of less than 5, or from 1 to 10, or from 1 to 9, or from 1 to 8, or from 1 to 7, or from 1 to 6, or from 1 to and a L* value of from 75 to 90, as determined by the L*a*b* color system of the CIE (International Commission on Illumination).

In one embodiment, the catalyst system utilized in the process(es) of the invention can comprise tin atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention can comprise titanium atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention can comprise manganese atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention can comprise zinc atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one embodiment, the catalyst system utilized in the process(es) of the invention can comprise germanium atoms in an amount of less than 30 ppm, or less than 20 ppm, or less than 10 ppm, or less than 5 ppm, or less than 2 ppm, or from 0 to 30 ppm, or from 0 to 20 ppm, or from 0 to 10 ppm, or 0 ppm, relative to the mass of final polyester being prepared.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of any of titanium atoms, tin atoms, and/or manganese atoms.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of any of titanium atoms, tin atoms, and/or zinc atoms.

In one embodiment, the polyesters and/or polyester compositions of the invention can comprise less than 30 ppm, or less than 20 ppm, or less than 10 ppm, or less than 5 ppm, or from 0 to 30 ppm, or from 0 to 20 ppm, or from 0 to 10 ppm, or 0 ppm, of any of titanium atoms, tin atoms, manganese atoms and/or zinc atoms.

In one embodiment, the polyesters and/or polyester compositions of the invention can have a number average molecular weight of from 4,800 to 16,000.

In one embodiment, the polyesters and/or polyester compositions of the invention can have an inherent viscosity of from 0.35 to 1.2 dL/g, or from 0.35 to 0.80 dL/g, or from 0.35 to 0.75 dL/g, or from 0.50 to 1.2 dL/g, or from 0.50 to 0.80 dL/g, or from 0.50 to 0.75 dL/g, or from 0.50 to 0.70 dL/g, or from 0.50 to 0.65 dL/g, or from 0.50 to 0.60 dL/g, or from 0.55 to 0.75 dL/g, or from 0.55 to 0.70 dL/g, or from 0.60 to 0.75 dL/g, or from 0.60 to 0.70 dL/g, as determined in 60/40 (wt/wt) phenol/tetrachloroethane at a concentration of 0.5 g/100 ml at 25° C.

In one embodiment, the polyesters and/or polyester compositions of the invention can have a Tg of from 85 to 130° C., or from 100 to 130° C., or from 100 to 125° C., or from 100 to 120° C.

In one embodiment, the polyesters and/or polyester compositions of the invention can have a b* value of from −10 to less than 20, or from −10 to less than 10, or from 1 to less than 20, or from 5 to less than 20, or from 8 to less than 20, or from −3 to 10, or from −5 to 5, or from −5 to 4, or from −5 to 3, or from 1 to 10, or from 1 to 9, or from 1 to 8, from 1 to 7, or from 1 to 6, or from 1 to 5, or less than 20, or less than 15, or less than 14, or less than 13, or less than 12, or less than 11, or less than 10, or less than 9, or less than 8.5, or less than 8, or less than 7, or less than 6, or less than 5, or less than 4, or less than 3, or from 1 to 10, or from 1 to 9, or from 1 to 8, or from 1 to 7, or from 1 to 6, or from 1 to 5, or from 2 to 6, as determined by the L*a*b* color system of the CIE (International Commission on Illumination).

In one embodiment the polyesters and/or polyester compositions of the invention can have a L* value of from 50 to 99, or from 50 to 90, or from 60 to 99, or from 60 to 90, or from 60 to 85, or from 60 to 80, or from 65 to 99, or from 65 to 90, or from 65 to 85, or from 65 to 80, or from 65 to 75, or from 70 to 90, or from 70 to 99, or from 70 to 90, or from 70 to 85, or from 75 to 85, or from 70 to 80, or from 75 to 95, or from 75 to 90, or from 75 to 85, or from to 90, as determined by the L*a*b* color system of the CIE (International Commission on Illumination).

In one embodiment, the b* and/or L* and/or a*values can be obtained in the presence of and/or in the absence of toner(s).

In one embodiment, the polyesters and/or polyester compositions made by the process(es) of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole % of TMCD residues;
      (ii) about 50 to about 90 mole % residues of diethylene glycol;
wherein the total mole % of the dicarboxylic acid component is 100 mole %,
wherein the total mole % of the diol component is 100 mole %; and
(2) residues of a catalyst system comprising lithium atoms and aluminum atoms; and optionally, less than 30 ppm, or less than 20 ppm, or less than 10 ppm, or less than 5 ppm, or from 0 to 30 ppm, or from 0 to 20 ppm, or from 0 to 10 ppm, or 0 ppm, of titanium atoms and/or tin atoms; wherein the inherent viscosity is from 0.35 to 1.2 dL/g, or from 0.55 to 0.75 dL/g, or 0.60 to 0.75 dL/g as determined in 60/40 (wt/wt) phenol/tetrachloroethane at a concentration of 0.5 g/100 ml at 25° C.; and having a b* value of less than 20, or of less than 15, or less than 14, or less than 13, or less than 12, or less than 11, or less than 10, or less than 9, or less than 8.5, or less than 8, or less than 7, or less than 6, or less than 5, or less than 4, or less than 3, or from 1 to 5, or from 1 to 6, or from 1 to 7, or from 1 to 8, or from 1 to 9, or from 1 to 10; and a L* value of from 75 to 95, or from 75 to 90, as determined by the L*a*b* color system of the CIE (International Commission on Illumination).

In one embodiment, the polyesters and/or polyester compositions made by the process(es) of the invention can comprise:
(1) at least one polyester which comprises:
   (a) a dicarboxylic acid component comprising:
      (i) about 70 to about 100 mole % residues of terephthalic acid or esters thereof;
      (ii) about 0 to about 30 mole % of aromatic and/or aliphatic dicarboxylic acid residues having up to 20 carbon atoms;
   (b) a glycol component comprising:
      (i) about 10 to about 50 mole % of TMCD residues;
      (ii) about 50 to about 90 mole % residues of CHDM;
wherein the total mole % of the dicarboxylic acid component of the final polyester is 100 mole % and
wherein the total mole % of the glycol component of the final polyester is 100 mole %; and
(2) residues comprising titanium atoms and zinc atoms; and optionally, less than 30 ppm, or less than 20 ppm, or less than 10 ppm, or less than 5 ppm, or from 0 to 30 ppm, or from 0 to 20 ppm, or from 0 to 10 ppm, or 0 ppm, of tin atoms;
wherein the inherent viscosity is from 0.35 to 0.75 dL/g, or 0.40 to 0.75, or 0.45 to 0.75 dL/g, as determined in 60/40 (wt/wt) phenol/tetrachloroethane at a concentration of 0.5 g/100 ml at 25° C.; and having a b* value of less than 20, of less than 15, or less than 14, or less than 13, or less than 12, or less than 11, or less than 10, or less than 9, or less than 8.5, or less than 8, or less than 7, or less than 6, or less than 5, or from 1 to 10, or from 1 to 9, or from 1 to 8, or from 1 to 7, or from 1 to 6, or from 1 to 5, or from 2 to 6; and a L* value of from 70 to 95 or from 75 to 90, as determined by the L*a*b* color system of the CIE (International Commission on Illumination). In some embodiments, the a* value can also be less than 7, or less than 4, or less than 3, or less than 2, or less than 1, or less than 0, or less than −1, or less than −1.5, or less than −2.

In one embodiment, the polyesters and/or polyester compositions made using the process(es) of the invention can contain no branching agent, or alternatively, at least one branching agent is added either prior to or during polymerization of the polyester.

In one embodiment, the polyesters and/or polyester compositions made using the process(es) of the invention can contain at least one branching agent without regard to the method or sequence in which it is added.

In one embodiment, the polyesters and/or polyester compositions of the invention can have a melt viscosity less than 30,000, or less than 20,000, or less than 12,000, or less than 10,000, or less than 7,000, or less than 5,000 poise, or less than 3,000 poise, as measured at 1 radian/second on a rotary melt rheometer at 290° C.

In one embodiment, the polyesters and/or polyesters compositions of the invention have a degree of polymerization of from 0.01 to 300, or 0.01 to 250, or 0.01 to 200, or 0.01 to 150, or 0.01 to 130, or 0.01 to 120, or 0.10 to 300, or 0.10 to 250, or 0.10 to 200, or 0.10 to 150, or 0.10 to 130, or 0.10 to 120, or 0.20 to 300, or 0.20 to 250, or 0.20 to 200, or 0.20 to 150, or 0.20 to 130, or 0.20 to 120, or 0.15 to 300, or 0.15 to 250, or 0.15 to 200, or 0.15 to 150, or 0.15 to 130, or 0.15 to 120.

In certain embodiments, the polyesters and/or polyester compositions of the invention can comprise from 0 to 10 mole percent, for example, from 0.01 to 5 mole percent, from 0.01 to 1 mole percent, from 0.05 to 5 mole percent, from 0.05 to 1 mole percent, or from 0.1 to 0.7 mole percent, based the total mole percentages of either the diol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the polyester. In certain embodiments, the polyester(s) useful in the invention can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole percent of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the polyester reaction mixture or blended with the polyester in the form of a concentrate as described, for example, in U.S. Pat. Nos. 5,654,347 and 5,696,176, whose disclosure regarding branching monomers is incorporated herein by reference.

The polyesters and/or polyester compositions of the invention can comprise at least one chain extender. Suitable chain extenders include, but are not limited to, multifunctional (including, but not limited to, bifunctional) isocyanates, multifunctional epoxides, including for example epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion. The amount of chain extender used can vary depending on the specific monomer composition used and the physical properties desired but is generally about 0.1 percent by weight to about 10 percent by weight, such as about 0.1 to about 5 percent by weight, relative to the mass of the final polyester.

The polyesters and/or polyester compositions of the invention can be visually clear. The term “visually clear” is defined herein as an appreciable absence of cloudiness, haziness, and/or muddiness, when inspected visually.

In one embodiment, the polyesters and/or polyester compositions of the invention, [in one embodiment, in the presence of and/or in the absence of toner(s)], can have color values L*, a* and b* which can be determined using a Hunter Lab Ultrascan Spectra Colorimeter manufactured by Hunter Associates Lab Inc., Reston, Va. The color determinations are averages of values measured on either pellets of the polyesters or plaques or other items injection molded or extruded from them. They are determined by the L*a*b* color system of the CIE (International Commission on Illumination) (translated), wherein L* represents the lightness coordinate, a* represents the red/green coordinate, and b* represents the yellow/blue coordinate.

In one embodiment, at least one phosphorous compound can be added during the process(es) of the invention.

It is believed that the color of these copolyesters of the invention can be improved with the addition during polymerization of certain levels of phosphorus containing compounds/stabilizers.

In one embodiment, the phosphorus compound(s) can be an organic compound such as, for example, a phosphorus acid ester containing halogenated or non-halogenated organic substituents. In certain embodiments, the phosphorus compound(s) can comprise a wide range of phosphorus compounds, for example, phosphines, phosphites, phosphinites, phosphonites, phosphinates, phosphonates, phosphine oxides, and phosphates.

Examples of phosphorus compounds that may be useful in the invention can include tributyl phosphate, triethyl phosphate, tri-butoxyethyl phosphate, t-butylphenyl diphenyl phosphate, 2-ethylhexyl diphenyl phosphate, ethyl dimethyl phosphate, isodecyl diphenyl phosphate, trilauryl phosphate, triphenyl phosphate, tricresyl phosphate, trixylenyl phosphate, t-butylphenyl diphenylphosphate, resorcinol bis(diphenyl phosphate), tribenzyl phosphate, phenyl ethyl phosphate, trimethyl thionophosphate, phenyl ethyl thionophosphate, dimethyl methylphosphonate, diethyl methylphosphonate, diethyl pentylphosphonate, dilauryl methylphosphonate, diphenyl methylphosphonate, dibenzyl methylphosphonate, diphenyl cresylphosphonate, dimethyl cresylphosphonate, dimethyl methylthionophosphonate, phenyl diphenylphosphinate, benzyl diphenylphosphinate, methyl diphenylphosphinate, trimethyl phosphine oxide, triphenyl phosphine oxide, tribenzyl phosphine oxide, 4-methyl diphenyl phosphine oxide, triethyl phosphite, tributyl phosphite, trilauryl phosphite, triphenyl phosphite, tribenzyl phosphite, phenyl diethyl phosphite, phenyl dimethyl phosphite, benzyl dimethyl phosphite, dimethyl methylphosphonite, diethyl pentylphosphonite, diphenyl methylphosphonite, dibenzyl methylphosphonite, dimethyl cresylphosphonite, methyl dimethylphosphinite, methyl diethylphosphinite, phenyl diphenylphosphinite, methyl diphenylphosphinite, benzyl diphenylphosphinite, triphenyl phosphine, tribenzyl phosphine, and methyl diphenyl phosphine. In one embodiment, triphenyl phosphine oxide is excluded as a thermal stabilizer in the process(es) of making the polyesters of the invention and/or in the polyester composition(s) of the invention.

In one embodiment, phosphorus compounds useful in the invention can be any of the previously described phosphorus-based acids wherein one or more of the hydrogen atoms of the acid compound (bonded to either oxygen or phosphorus atoms) are replaced with alkyl, branched alkyl, substituted alkyl, alkyl ethers, substituted alkyl ethers, alkyl-aryl, alkyl-substituted aryl, aryl, substituted aryl, and mixtures thereof. In another embodiment, phosphorus compounds useful in the invention, include but are not limited to, the above described compounds wherein at least one of the hydrogen atoms bonded to an oxygen atom of the compound is replaced with a metallic ion or an ammonium ion.

The esters can contain alkyl, branched alkyl, substituted alkyl, alkyl ethers, aryl, and/or substituted aryl groups. The esters can also have at least one alkyl group and at least one aryl group. The number of ester groups present in the particular phosphorus compound can vary from zero up to the maximum allowable based on the number of hydroxyl groups present on the phosphorus compound used. For example, an alkyl phosphate ester can include one or more of the mono-, di-, and tri alkyl phosphate esters; an aryl phosphate ester includes one or more of the mono-, di-, and tri aryl phosphate esters; and an alkyl phosphate ester and/or an aryl phosphate ester also include, but are not limited to, mixed alkyl aryl phosphate esters having at least one alkyl and one aryl group.

In one embodiment, the phosphorus compounds useful in the invention include but are not limited to alkyl, aryl or mixed alkyl aryl esters or partial esters of phosphoric acid, phosphorus acid, phosphinic acid, phosphonic acid, or phosphonous acid. The alkyl or aryl groups can contain one or more substituents.

In one embodiment, the phosphorus compounds useful in the invention comprise at least one phosphorus compound chosen from at least one of substituted or unsubstituted alkyl phosphate esters, substituted or unsubstituted aryl phosphate esters, substituted or unsubstituted mixed alkyl aryl phosphate esters, diphosphites, salts of phosphoric acid, phosphine oxides, and mixed aryl alkyl phosphites, reaction products thereof, and mixtures thereof. The phosphate esters include esters in which the phosphoric acid is fully esterified or only partially esterified.

In one embodiment, for example, the phosphorus compounds useful in the invention can include at least one phosphate ester.

In another embodiment, the phosphate esters useful in the invention can include but are not limited to alkyl phosphate esters, aryl phosphate esters, mixed alkyl aryl phosphate esters, and/or mixtures thereof.

In certain embodiments, the phosphate esters useful in the invention are those where the groups on the phosphate ester include are alkyl, alkoxy-alkyl, phenyl, or substituted phenyl groups. These phosphate esters are generally referred to herein as alkyl and/or aryl phosphate esters. Certain preferred embodiments include trialkyl phosphates, triaryl phosphates, alkyl diaryl phosphates, dialkyl aryl phosphates, and mixtures of such phosphates, wherein the alkyl groups are preferably those containing from 2 to 12 carbon atoms, and the aryl groups are preferably phenyl.

Representative alkyl and branched alkyl groups are preferably those containing from 1-12 carbon atoms, including, but not limited to, ethyl, propyl, isopropyl, butyl, hexyl, cyclohexyl, 2-ethylhexyl, octyl, decyl and dodecyl. Substituted alkyl groups include, but are not limited to, those containing at least one of carboxylic acid groups and esters thereof, hydroxyl groups, amino groups, keto groups, and the like.

Representative of alkyl-aryl and substituted alkyl-aryl groups are those wherein the alkyl portion contains from 1-12 carbon atoms, and the aryl group is phenyl or substituted phenyl wherein groups such as alkyl, branched alkyl, aryl, hydroxyl, and the like are substituted for hydrogen at any carbon position on the phenyl ring. Preferred aryl groups include phenyl or substituted phenyl wherein groups such as alkyl, branched alkyl, aryl, hydroxyl and the like are substituted for hydrogen at any position on the phenyl ring.

In one embodiment, the phosphate esters useful in the invention include but are not limited to dibutylphenyl phosphate, triphenyl phosphate, tricresyl phosphate, tributyl phosphate, tri-2-ethylhexyl phosphate, trioctyl phosphate, and/or mixtures thereof, including particularly mixtures of tributyl phosphate and tricresyl phosphate, and mixtures of isocetyl diphenyl phosphate and 2-ethylhexyl diphenyl phosphate.

In one embodiment, at least one phosphorus compound useful in the invention comprises at least one aryl phosphate ester.

In one embodiment, at least one phosphorus compound useful in the invention comprises at least one unsubstituted aryl phosphate ester.

In one embodiment, at least one phosphorus compound useful in the invention comprises at least one aryl phosphate ester which is not substituted with benzyl groups.

In one embodiment, any of the phosphorus compounds useful in the invention may comprise at least one alkyl phosphate ester.

In one embodiment, the phosphate esters useful in the invention as thermal stabilizers and/or color stabilizers include but are not limited to, at least one of the following: trialkyl phosphates, triaryl phosphates, alkyl diaryl phosphates, and mixed alkyl aryl phosphates.

In one embodiment, the phosphate esters useful in the invention as thermal stabilizers and/or color stabilizers include but are not limited to, at least one of the following: triaryl phosphates, alkyl diaryl phosphates, and mixed alkyl aryl phosphates.

In one embodiment, the phosphate esters useful as thermal stabilizers and/or color stabilizers in the invention can include but are not limited to, at least one of the following: triaryl phosphates and mixed alkyl aryl phosphates.

In one embodiment, at least one phosphorus compound useful in the invention can comprise, but is not limited to, triaryl phosphates, such as, for example, triphenyl phosphate. In one embodiment, at least one thermal stabilizer comprises, but is not limited to Merpol A. In one embodiment, at least one thermal stabilizer useful in the invention comprises, but is not limited to, at least one of triphenyl phosphate and Merpol A. Merpol A is a phosphate ester commercially available from Stepan Chemical Co and/or E.I. duPont de Nemours & Co. The CAS Registry number for Merpol A is believed to be CAS Registry #37208-27-8.

In one embodiment, any of the phosphorus compounds useful in the invention may comprise at least one triaryl phosphate ester which is not substituted with benzyl groups.

In one embodiment, the polyester compositions and/or processes of the invention may comprise 2-ethylhexyl diphenyl phosphate.

In one embodiment, any of the processes described herein for making any of the polyester compositions and/or polyesters of the invention can comprise at least one mixed alkyl aryl phosphite, such as, for example, bis(2,4-dicumylphenyl)pentaerythritol diphosphite also known as Doverphos S-9228 (Dover Chemicals, CAS #15486243-8).

In one embodiment, any of the processes described herein for making any of the polyester compositions and/or polyesters of the invention can comprise at least one phosphine oxide.

In one embodiment, any of the processes described herein for making any of the polyester compositions and/or polyesters of the invention can comprise at least one salt of phosphoric acid such as, for example, KH2PO4 and Zn3(PO4)2.

The term “thermal stabilizer” is intended to include the reaction product(s) thereof. The term “reaction product” as used in connection with the thermal stabilizers of the invention refers to any product of a polycondensation or esterification reaction between the thermal stabilizer and any of the monomers used in making the polyester as well as the product of a polycondensation or esterification reaction between the catalyst and any other type of additive.

In one embodiment of the invention, the phosphorus compounds useful in the invention may act as thermal stabilizers. In one embodiment of the invention, the phosphorus compounds useful in the invention may not act as a thermal stabilizer but may act as a color stabilizer. In one embodiment of the invention, the phosphorus compounds useful in the invention may act as both a thermal stabilizer and a color stabilizer.

In one embodiment, amounts of the phosphate ester of the invention added during polymerization are chosen from the following: 10 to 200 ppm relative to the mass of the final polyester composition and as measured in the form of phosphorus atoms in the final polyester. In certain embodiments of the invention, phosphorous can be present in an amount of 10 to 100, or 10 to 80, or 10 to 60, or 10 to 55, or 15 to 55, or 18 to 52, or 20 to 50 ppm, relative to the mass of the final polyester composition and as measured in the form of phosphorus atoms in the final polyester.

In one embodiment, the polyester compositions of the invention can contain no crosslinking agent.

In one embodiment, there is provided a process for making any of the polyester compositions of the invention comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) 70 to 100 mole % of terephthalic acid residues;
      (ii) 0 to 30 mole % of aromatic dicarboxylic acid residues having up to 20 carbon atoms; and
      (iii) 0 to 10 mole % of aliphatic dicarboxylic acid residues having up to 16 carbon atoms; and
   (b) a glycol component comprising:
      (i) 10 to 50 mole % of cis-TMCD residues in the amount of 90 mole % or greater; and trans-TMCD residues in the amount of 10 mole % or less; and
      (ii) 50 to 90 mole % of CHDM residues;
wherein the molar ratio of glycol component/dicarboxylic acid component added in Step (I) is 1.0-1.5/1.0;
(II) heating the product of Step (I) at a temperature of 230° C. to 320° C. for 1 to 6 hours under at least one pressure chosen from the range of the final pressure of Step (I) to 0.02 torr absolute;
wherein the mixture in Steps (I) or (II), respectively, when heated, is heated in the presence of at least one catalyst system comprising: at least one aluminum compound and at least one lithium compound; or at least one titanium compound and at least one zinc compound; and
wherein the final product after Step (II) comprises either: lithium atoms and aluminum atoms; or titanium atoms and zinc atoms;
wherein the total mole % of the dicarboxylic acid component of the final polyester is 100 mole %;
wherein the total mole % of the glycol component of the final polyester is 100 mole %;
wherein the inherent viscosity of the final polyester is from 0.35 to 1.2 dL/g as determined in 60/40 (wt/wt) phenol/tetrachloroethane at a concentration of 0.25 g/50 ml at 25° C.; and
wherein the final polyester has a Tg from 85° C. to 150° C.

In one embodiment, the process above is provided except that the lithium source is added in Step (I) and the source of said aluminum source is added in Step (II).

In one embodiment, the process above is provided except that the titanium source is added in Step (I) and the source of said zinc source is added in Step (II).

In one embodiment, the extent of TMCD incorporation or conversion in the final polymer can be greater than 55 mole %; or greater than mole %; or greater than 45 mole %; or 45 mole % or greater; greater than 40 mole %; or greater than 35 mole %; or greater than 30 mole %.

In one embodiment, the invention relates to a process for making a polyester comprising the following steps:
(I) heating a mixture at least one temperature chosen from 150° C. to 300° C., under at least one pressure chosen from the range of 0 psig to 100 psig wherein said mixture comprises:
   (a) a dicarboxylic acid component comprising:
      (i) about 90 to about 100 mole % of terephthalic acid residues;
      (ii) about 0 to about 10 mole % of aromatic and/or aliphatic dicarboxylic acid residues having up to 20 carbon atoms; and
   (b) a glycol component comprising:
      (i) about 10 to about 50 mole % TMCD residues; and
      (ii) about 50 to about 90 mole % of CHDM residues;
wherein the molar ratio of glycol component/dicarboxylic acid component added in Step (I) is 1.01-3.0/1.0 and wherein TMCD is added in an amount from about 10 to 50 mole %, to arrive at a final polymer having about 10 to 50 mole % TMCD residues;
wherein the mixture in Step (I) is heated in the presence of:
(i) a catalyst system comprising either: lithium atoms and aluminum atoms; or titanium atoms and zinc atoms; and (ii) and, optionally, at least one phosphorus compound;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %; and wherein the total mole % of the glycol component of the final polyester is 100 mole %;
wherein the inherent viscosity of the polyester is from 0.50 to 0.80 dL/g as determined in 60/40 (wt/wt) phenol/tetrachloroethane at a concentration of 0.25 g/50 ml at 25° C.; and wherein the L* color values for the polyester is 75 or greater, as determined by the L*a*b* color system of the CIE (International Commission on Illumination).

In one embodiment, the above-described catalyst system utilized in the process(es) of the invention comprises lithium atoms and aluminum atoms.

In one embodiment, the above-described catalyst system utilized in the process(es) of the invention comprises titanium atoms and zinc atoms.

In certain embodiments of the invention, the above-described catalyst system comprises no tin and/or no titanium.

It is believed that any of the processes of making the polyesters useful in the invention may be used to make any of the polyesters and/or polyester compositions useful in the invention.

In one embodiment, the pressure used in Step (I) of any of the processes of the invention can consist of at least one pressure chosen from 0 psig to 75 psig. In one embodiment, the pressure used in Step (I) of any of the processes of the invention consists of at least one pressure chosen from 0 psig to 50 psig.

In one embodiment, the pressure used in Step (II) of any of the processes of the invention can consist of at least one pressure chosen from 20 torr absolute to 0.02 torr absolute; in one embodiment, the pressure used in Step (II) of any of the processes of the invention can consist of at least one pressure chosen from 10 torr absolute to 0.02 torr absolute; in one embodiment, the pressure used in Step (II) of any of the processes of the invention can consist of at least one pressure chosen from 5 torr absolute to 0.02 torr absolute; in one embodiment, the pressure used in Step (II) of any of the processes of the invention can consist of at least one pressure chosen from 3 torr absolute to 0.02 torr absolute; in one embodiment, the pressure used in Step (II) of any of the processes of the invention can consist of at least one pressure chosen from 20 torr absolute to 0.1 torr absolute; in one embodiment, the pressure used in Step (II) of any of the processes of the invention can consist of at least one pressure chosen from 10 torr absolute to torr absolute; in one embodiment, the pressure used in Step (II) of any of the processes of the invention can consist of at least one pressure chosen from 5 torr absolute to 0.1 torr absolute; in one embodiment, the pressure used in Step (II) of any of the processes of the invention can consist of at least one pressure chosen from 3 torr absolute to 0.1 torr absolute.

In one embodiment, the molar ratio of glycol component/dicarboxylic acid component added in Step (I) of any of the processes of the invention is 1.0-3.0/1.0; In one embodiment, the molar ratio of glycol component/dicarboxylic acid component added in Step (I) of any of the processes of the invention is 1.0-2.5/1.0; In one embodiment, the molar ratio of glycol component/dicarboxylic acid component added in Step (I) of any of the processes of the invention is 1.0-2.0/1.0; In one embodiment, the molar ratio of glycol component/dicarboxylic acid component added in Step (I) of any of the processes of the invention is 1.0-1.75/1.0; In one embodiment, the molar ratio of glycol component/dicarboxylic acid component added in Step (I) of any of the processes of the invention is 1.0-1.5/1.0.

In any of the process embodiments for making the polyesters useful in the invention, the heating time of Step (II) may be from 1 to 5 hours. In any of the process embodiments for making the polyesters useful in the invention, the heating time of Step (II) may be from 1 to 4 hours. In any of the process embodiments for making the polyesters useful in the invention, the heating time of Step (II) may be from 1 to 3 hours. In any of the process embodiments for making the polyesters useful in the invention, the heating time of Step (II) may be from 1.5 to 3 hours. In any of the process embodiments for making the polyesters useful in the invention, the heating time of Step (II) may be from 1 to 2 hours.

In one embodiment, the processes of the invention of making polyesters of the invention can comprise a batch or continuous process.

In one embodiment, the processes of the invention of making polyesters of the invention can comprise a continuous process.

The weight of aluminum atoms and lithium atoms, or titanium atoms and zinc atoms, present in the final polyester can be measured in the final polyester in any of the aforesaid weight ratios, for example.

In one embodiment, the polyesters and/or polyester compositions of the invention can be used in various types of film and/or sheet, including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

In one embodiment, the invention relates to thermoformed film(s) and/or sheet(s) comprising the polyester(s) and/or polyester compositions of the invention.

In one embodiment, the invention relates to articles of manufacture which incorporate the thermoformed film and/or sheet of the invention.

In certain embodiments of the invention, certain agents which colorize the polymer can be added to the melt. In one embodiment, a bluing toner is added to the melt in order to reduce the b* of the resulting polyester polymer melt phase product. Such bluing agents include blue inorganic and organic toner(s). In addition, red toner(s) can also be used to adjust the a* color. Organic toner(s), e.g., blue and red organic toner(s), such as those toner(s) described in U.S. Pat. Nos. 5,372,864 and 5,384,377, which are incorporated by reference in theft entirety, can be used. The organic toner(s) can be fed as a premix composition. The premix composition may be a neat blend of the red and blue compounds or the composition may be pre-dissolved or slurried in one of the polyester's raw materials, e.g., ethylene glycol.

The total amount of toner components added can depend on the amount of inherent yellow color in the base polyester and the efficacy of the toner. In one embodiment, a concentration of up to about 15 ppm of combined organic toner components and a minimum concentration of about ppm are used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor.

The invention further relates to a polymer blend. The blend comprises:
(a) from 5 to 95 weight % of at least one of the polyesters made using any of the processes described herein; and
(b) from 5 to 95 weight % of at least one of the polymeric components.

Suitable examples of the polymeric components include, but are not limited to, nylon; polyesters different than those described herein such as PET; polyamides such as ZYTEL® from DuPont; polystyrene; polystyrene copolymers; styrene acrylonitrile copolymers; acrylonitrile butadiene styrene copolymers; poly(methylmethacrylate); acrylic copolymers; poly(ether-imides) such as ULTEM® (a poly(ether-imide) from General Electric); polyphenylene oxides such as poly(2,6-dimethylphenylene oxide) or polyphenylene oxide)/polystyrene blends such as NORYL 1000® (a blend of poly(2,6-dimethylphenylene oxide) and polystyrene resins from General Electric); polyphenylene sulfides; polyphenylene sulfide/sulfones; poly(ester-carbonates); polycarbonates such as LEXAN® (a polycarbonate from General Electric); polysulfones; polysulfone ethers; and poly(ether-ketones) of aromatic dihydroxy compounds; or mixtures of any of the foregoing polymers. The blends can be prepared by conventional processing techniques known in the art, such as melt blending or solution blending.

In one embodiment, the polyester compositions of the invention can comprise at least one polycarbonate, or no polycarbonate, or no carbonate groups.

In certain embodiments, the polyester compositions and the polymer blend compositions can also contain from 0.01 to 25% by weight of the overall composition common additives such as colorants, toner(s), dyes, mold release agents, flame retardants, plasticizers, nucleating agents, stabilizers, including but not limited to, UV stabilizers, thermal stabilizers other than the phosphorus compounds describe herein, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the polyester composition.

Reinforcing materials may be added to the polyesters and/or polyester compositions. The reinforcing materials may include, but are not limited to, carbon filaments, silicates, mica, clay, talc, titanium dioxide, Wollastonite, glass flakes, glass beads and fibers, and polymeric fibers and combinations thereof. In one embodiment, the reinforcing materials include glass, such as, fibrous glass filaments, mixtures of glass and talc, glass and mica, and glass and polymeric fibers.

In one embodiment, the polyesters and/or polyester compositions of the invention are useful in shaped articles, including, but not limited to, extruded, and/or molded articles including, but not limited to, injection molded articles, extruded articles, cast extrusion articles, profile extrusion articles, melt spun articles, thermoformed articles, extrusion molded articles, injection blow molded articles, injection stretch blow molded articles, extrusion blow molded articles and extrusion stretch blow molded articles. These articles can include, but are not limited to, films, bottles, containers, drinkware, medical parts, sheet and/or fibers.

In one embodiment, the invention relates to thermoformed film(s) and/or sheet(s) comprising the polyester(s) and/or polyester compositions of the invention.

In one embodiment, the invention relates to articles of manufacture made with the polyesters and/or polyester compositions described herein. These articles of manufacture can incorporate the thermoformed film and/or sheet of the invention.

In one embodiment, the invention relates to film(s) and/or sheet(s) comprising the polyesters, polyester compositions, and/or polymer blends of the invention. The methods of forming the polyesters and/or blends into film(s) and/or sheet(s) are well known in the art. Examples of film(s) and/or sheet(s) of the invention including but not limited to extruded film(s) and/or sheet(s), compression molded film(s) and/or sheet(s), solution casted film(s) and/or sheet(s). Methods of making film and/or sheet include but are not limited to extrusion, compression molding, and solution casting.

Examples of potential articles made from film and/or sheet comprising polyesters and/or polyester compositions of the invention, include but are not limited to, thermoformed sheet, graphic arts film, outdoor signs, ballistic glass, skylights, coating(s), coated articles, painted articles, shoe stiffeners, laminates, laminated articles, medical packaging, general packaging, and/or multiwall films or sheets.

In one embodiment, the invention relates to injection molded articles comprising the polyester compositions and/or polymer blends of the invention. Injection molded articles can include injection stretch blow molded bottles, sun glass frames, lenses, sports bottles, drinkware, food containers, medical devices and connectors, medical housings, electronics housings, cable components, sound dampening articles, cosmetic containers, wearable electronics, toys, promotional goods, appliance parts, automotive interior parts, and consumer houseware articles.

The polyesters of the invention can be amorphous or semicrystalline. In one embodiment, certain polyesters useful in the invention can have relatively low crystallinity. Certain polyesters useful in the invention can thus have a substantially amorphous morphology, meaning that the polyesters comprise substantially unordered regions of polymer.

Notched Izod impact strength, as described in ASTM D256, is a common method of measuring toughness. In one embodiment, the polyester compositions of the invention can have a notched Izod impact strength of at least 1 ft-lbs/inch, or at least 2 ft-lbs/inch, or at least 3 ft-lbs/inch, or at least 7.5 ft-lbs/in, or at least 10 ft-lbs/in at 23° C. according to ASTM D256 with a 10-mil notch in a ⅛-inch thick bar.

Notched Izod impact strength is measured herein at 23° C. with a notch in a 3.2 mm (⅛-inch) thick bar determined according to ASTM D256. In one embodiment, certain polyesters useful in the invention can exhibit a notched Izod impact strength of at least 25 J/m (0.47 ft-lb/in) at 23° C. with a 10-mil notch in a 3.2 mm (⅛-inch) thick bar determined according to ASTM D256. In another embodiment, certain polyesters and/or polyester compositions made by the process(es) of the invention can exhibit a notched Izod impact strength of from about 50 J/m (0.94 ft-lb/in) to about 75 J/m (1.41 ft-lb/in) at 23° C. with a 10-mil notch in a 3.2 mm (⅛-inch) thick bar determined according to ASTM D256.

In one embodiment, certain polyesters made by the process(es) of the invention can exhibit a density of greater than 1.2 g/ml at 23° C.

In one embodiment, certain polyesters and/or polyester compositions of the invention of the invention can exhibit useful thermal stability of not more than 0.20 dL/g loss in inherent viscosity, or not more than 0.15 dL/g loss in inherent viscosity, or not more than 0.12 dL/g loss in inherent viscosity, or not more than 0.10 dL/g loss in inherent viscosity when heated at 300° for 1 to 5 hours, or from 1 to 4 hours, or from 2 to 3 hours, or for 2.5 hours, where inherent viscosity is determined in 60/40 (wt/wt) phenol/tetrachloroethane at a concentration of 0.5 g/100 ml at 25° C.

In one embodiment, the inherent viscosity of the final polyester can be from 0.35 to 1.2 dL/g, or from 0.35 to 0.80 dL/g, or 0.35 to 0.75 dL/g, or from 0.50 to 1.2 dL/g, or from 0.50 to 0.80 dL/g, or from 0.50 to 0.75 dL/g, or from 0.50 to 0.70 dL/g, or from 0.50 to 0.65 dL/g, or from 0.50 to 0.60 dL/g, or from 0.55 to 0.75 dL/g, or from 0.55 to 0.70 dL/g, or from 0.60 to 0.75 dL/g, or from 0.60 to 0.70 dL/g, as determined in 60/40 (wt/wt) phenol/tetrachloroethane at a concentration of 0.5 g/100 ml at 25° C.

In one embodiment, certain polyesters of the invention can exhibit a flexural modulus at 23° C. equal to or greater than 2000 MPa (290,000 psi) as defined by ASTM D790. In another embodiment, certain polyesters and/or polyester compositions of the invention can exhibit a tensile strength at 23° C. from about 2000 MPa (290,000 psi) to about 2551 MPa (370,000 psi) as defined by ASTM D638. In another embodiment, certain polyesters and/or polyester compositions of the invention can exhibit a flexural modulus at 23° C. from about 2000 MPa (290,000 psi) to about 2413 MPA (350,000 psi) as defined by ASTM D790.

Certain polyesters and/or polyester compositions of the invention can possess at least one of the following properties: a Tg of from about 85 to about 130° C. as measured by a TA 2100 Thermal Analyst Instrument at a scan rate of 20° C./min; a flexural modulus at 23° C. equal to or greater than 2000 MPa (290,000 psi) as defined by ASTM D790; and a notched Izod impact strength equal to or greater than 25 J/m (0.47 ft-lb/in) according to ASTM D256 with a 10-mil notch using a ⅛-inch thick bar at 23° C.

In one embodiment, the final polyesters and/or final polyester compositions of the invention can be useful for non-coating compositions, non-adhesive compositions, thermoplastic polyester compositions, articles of manufacture, shaped articles, thermoplastic shaped articles, molded articles, extruded articles, injection molded articles, blow molded articles, film and/or sheet (for example, calendered, cast, or extruded), thermoformed film or sheet, container, or bottle (for example, baby bottles or sports bottles or water bottles).

In one embodiment, the present invention comprises a thermoplastic article, typically in the form of sheet material, having a decorative material embedded therein which comprise any of the polyesters and/or polyester compositions described herein.

In one embodiment, the polyesters and/or polyester compositions of the invention can be used for appliance parts. “Appliance parts,” as used herein, refers to a rigid piece used in conjunction with an appliance. In one embodiment, the appliance part is partly or wholly separable from the appliance. In another embodiment, the appliance part is one that is typically made from a polymer. In one embodiment, the appliance part is visually clear.

In one embodiment, the final polyesters and/or final polyester compositions of the invention can be used for bottles and containers including those that are injection molded, injection blow molded, injection stretch blow molded, blow molded, or reheat blow molded. Articles made by these methods include dual wall tumblers, water bottles, sports bottles, bulk water containers, and baby bottles.

The following examples further illustrate how the polyesters of the invention can be made and evaluated, and are intended to be purely exemplary of the invention and are not intended to limit the scope thereof. Unless indicated otherwise, parts are parts by weight, temperature is in degrees C. or is at room temperature, and pressure is at or near atmospheric.

### EXAMPLES

The following examples illustrate, in general, how copolyesters of this invention are prepared and the effect of using 2,2,4,4-tetramethyl-1,3-cyclobutanediol and modifying glycols, and certain catalyst and stabilizers, on various copolyester properties such as color and inherent viscosity (IV).

### Measurement Methods

The inherent viscosity (IV or I.V.) of the polyesters was determined in 60/40 (wt/wt) phenol/tetrachloroethane at a concentration of 0.5 g/100 ml at 25° C., and is reported in dL/g.

The glycol content and the cis/trans ratio of the compositions were determined by proton nuclear magnetic resonance (NMR) spectroscopy. All NMR spectra were recorded on a JEOL Eclipse Plus 600 MHz nuclear magnetic resonance spectrometer using either chloroform-trifluoroacetic acid (70-30 volume/volume) for polymers or, for oligomeric samples, 60/40 (wt/wt) phenol/tetrachloroethane with deuterated chloroform added for lock. Peak assignments for 2,2,4,4-tetramethyl-1,3-cyclobutanediol resonances were made by comparison to model mono- and dibenzoate esters of 2,2,4,4-tetramethyl-1,3-cyclobutanediol. These model compounds closely approximate the resonance positions found in the polymers and oligomers.

Color values reported herein are CIELAB L*, a*, and b* values measured following ASTM D6290-98 and ASTM E308-99, using measurements from a Hunter Lab Ultrascan XE Spectrophotometer (Hunter Associates Laboratory Inc., Reston, Va.) with the following parameters: (1) D65 illuminant, (2) 10 degree observer, (3) reflectance mode with specular angle included, (4) large area view, (5) 1″ port size. Unless stated otherwise, the measurements were performed on polymer granules ground to pass a 1 mm sieve.

The amount of aluminum (Al), lithium (Li), titanium (Ti), zinc (Zn) and tin (Sn) in the examples below is reported in parts per million (ppm) of metal and was measured by inductively coupled plasma mass spectrometry. The amount of phosphorous is similarly reported as ppm of elemental phosphorus and was also measured by inductively coupled plasma mass spectrometry (ICP).

Unless otherwise specified, the cis/trans ratio of the 2,2,4,4-tetramethyl-1,3-cyclobutanediol used in the following examples was approximately 50/50 and could range from 45/55 to 99/1.9

### Examples 1-9—Preparation of the Copolyesters of the Invention

The copolyesters of Examples 1-9 in Table 3 generally target a composition comprising 100 mole % dimethyl terephthalate residues, 35 mole % TMCD residues, and 65 mole % CHDM residues. A process for the preparation of the copolyesters as shown in Table 3 is generally exemplified (using lithium and aluminum in this particular example) as follows: A mixture of 77.6 g of dimethyl terephthalate, 38.4 g of CHDM, 25.2 g of TMCD, 0.089 g of lithium acetylacetonate, and 0.070 g of aluminum acetylacetonate was placed in a 500-milliliter flask equipped with an inlet for nitrogen, a metal stirrer, and a short distillation column. The flask was placed in a Wood's metal bath already heated to 220° C. The stirring speed was set to 175 RPM and this was held for 15 minutes. The contents of the flask were heated to 230° C. over 5 minutes while the stirring was simultaneous raised to 225° C. over that time. The contents were then raised to 245° C. slowly over 45 minutes. The contents remained at 245° C. while the pressure was reduced to 250 torr over three minutes. The temperature was again raised to 265° C. over the course of 15 minutes. The pressure was then further reduced to 3.5 torr over the course of eight minutes. Finally, the temperature was increased to 277° C. while the stir rate slowly decreased to 50 RPM and the pressure dropped to 1 torr over the course of 20 minutes. The reaction was held at this final temperature, pressure and stir rate for 35 minutes. A high melt viscosity, visually clear polymer was obtained with an inherent viscosity of 0.63 dl/g. NMR analysis showed that the polymer was composed of 32.5% TMCD residues. Analysis of the condensates after esterification and polycondensation and completion of mass balance calculations revealed a TMCD percent yield of 96.3%.

The standard monomer charges and reaction sequence are below in Tables 1 and 2. Upon completion of the reaction the polymer was ground to a 6 mm particle size and submitted for molecular weight, composition and color analyses.

For reactions where a TMCD yield was obtained each piece of glassware was weighed before and after the reaction. This allowed for tracking of TMCD and the degradation products using GC analysis. The condensates from the two traps downstream from the reactor were sampled to obtain the composition of the liquid. Note that trap 1 was changed between stages 5 and 6 in Table 2 to collect condensate information for the front end esterification and backend polycondensation stages.

TABLE 1
Typical monomer charges used in Copolyester A synthesis.

| Reagent | Excess | Target grams |
|---|---|---|
| DMT | 0.4 | 77.7 |
| CHDM | 0.27 | 38.4 |
| TMCD | 0.18 | 25.2 |

TABLE 2
Camile Sequence used for synthesis of Copolyester A.

| | Time | Temperature | Vacuum | Stir |
|---|---|---|---|---|
| Stage | (min) | (° C.) | (torr) | (rpm) |
| 1 | 0.1 | 220 | 730 | 0 |
| 2 | 15 | 220 | 730 | 175 |
| 3 | 5 | 230 | 730 | 225 |
| 4 | 1 | 230 | 730 | 225 |
| 5 | 45 | 245 | 730 | 225 |
| 6 | 3 | 245 | 250 | 225 |
| 7 | 15 | 265 | 250 | 225 |
| 8 | 8 | 277 | 3.5 | 225 |
| 9 | 5 | 277 | 3.5 | 150 |
| 10 | 10 | 277 | 3.5 | 100 |
| 11 | 5 | 277 | 1 | 75 |

With the mass balance and gas chromatography (GC) information the amount of TMCD and the corresponding degradation species were quantified. Table 3 details the TMCD degradation products, dimethyl pentanone and pentenal, as a function of catalyst and TMCD choice. Experiments with monobutyltin tris(2-ethylhexanoate) provided a set of control data which the Li/Al and Zn/Ti packages were compared against. For comparison purposes, specifically, the first row of table 3 is considered the Sn base case as it also employed TMCD with a cis/trans ratio of 55:45.

TABLE 3
Comparison of TMCD yields for Sn-, Li/Al-, and Zn/Ti-catalyzed Polyesters Comprising TMCD and CHDM.
(Each row is the average of at least 3 different experiments except for Examples 5-7)

| | | TMCD | | | | | | | | TMCD | TMCD | TMCD |
|---|---|---|---|---|---|---|---|---|---|---|---|---|
| Ex. | | cis-trans | ppm | | | | TMCD | DMP | Pentenal | degraded | Added | Yield |
| # | Catalyst | ratio | M+ | b* | L* | IV | mol % | (grams) | (grams) | (grams) | (grams) | (%) |
| 1 | Sn | 55:45 | 159 | 1.6 | 80.4 | 0.69 | 34.0 | 0.74 | 0.07 | 1.07 | 25.76 | 95.8 |
| 2 | Sn | 95:5 | 131 | 5.2 | 82.0 | 0.64 | 33.1 | 0.51 | 0 | 0.71 | 26.21 | 97.3 |
| 3 | Li/Al | 55:45 | 57/60 | 2.7 | 78.7 | 0.64 | 32.5 | 0.07 | 0.78 | 0.93 | 25.65 | 96.4 |
| 4 | Li/Al | 95:5 | 60/57 | 15.2 | 66.8 | 0.60 | 31.2 | 0.03 | 0.09 | 0.14 | 25.74 | 99.5 |
| 5 | Li/Al | 94.76:5.24 | 58.2/52.4 | 5.9 | 83.62 | 0.58 | 30.9 | N/A | N/A | N/A | N/A | N/A |
| 6 | Li/Al | 94.01:5.99 | 57.1/55.7 | 5.27 | 85.41 | 0.536 | 32.53 | N/A | N/A | N/A | N/A | N/A |
| 7 | Li/Al | 92.85:7.15 | 61.5/60.9 | 4.1 | 81.75 | 0.531 | 33.34 | N/A | N/A | N/A | N/A | N/A |
| 8 | Zn/Ti | 55:45 | 160/192 | 5.4 | 83.0 | 0.58 | 32.4 | 0.13 | 0.91 | 1.14 | 25.43 | 95.5 |
| 9 | Zn/Ti | 95:5 | 140/193 | 5.0 | 82.1 | 0.55 | 32.6 | 0.14 | 0.02 | 0.21 | 25.44 | 99.2 |

Examples 1, 3 and 8 contain different catalyst systems (Ex. 1-Sn, Ex 3-Li/Al and Ex. 5-Ti/Zn) being used with 55/45 mole % cis/trans-TMCD). Examples 2, 4, and 6 contain different catalyst systems (Ex. 2-Sn, Ex 4-Li/Al and Ex. 8-Ti/Zn) being used with 95/5 mole % cis/trans-TMCD).

When Examples 1 and 2 (both Sn) are compared, Example 2 exhibited an improvement in yield of 1.45% compared to Example 1.

When Examples 3 and 4 (both Li/Al) are compared, Example 4 exhibited an improvement in yield of 3.07% compared to Example 3. The trap was not changed in Examples 5, 6 and 7.

When Examples 8 and 9 (both Ti/Zn) are compared, Example 9 exhibited an improvement in yield of 3.67% compared to Example 8.

In summary, it is shown that the use of 95/5 mole % cis/trans-TMCD in the three different catalyst systems results in better % yield TMCD than use of 55/45 mole % cis/trans-TMCD; for all of these three catalyst systems and for each catalyst system in these Examples 1-4 and 8-9, the % yield improvement is at least 3.5% or greater, or 3.0% or greater, or at least 2.5% or greater, or at least 2.0% or greater, or at least 1.5% or greater, or at least 1.4% or greater, or at least 1.2% or greater, or at least 1.0% or greater. The % yield improvement was not measured for Examples 5-7.

In comparing Examples 2 and 4, Example 4 (Li/Al) demonstrates more than 2 times the % yield of Example 2(Sn) (both using the 95/5 mole % cis/trans-TMCD). In summary, the Li/Al catalyst system results in better % TMCD yield than the Sn catalyst system when 95/5 mole % cis/trans-TMCD is used for each process.

In comparing Examples 2 and 9, Example 9 (Ti/Zn) demonstrates more than 2.5 times the % yield of Example 2(Sn) (both using the 95/5 mole % cis/trans-TMCD). It has been demonstrated that the Ti/Zn catalyst system results in better % TMCD yield than the Sn catalyst system when 95/5 mole % cis/trans-TMCD is used for each process.

In comparing Examples 1 and 4, Example 4 (Li/Al) demonstrated improvement in TMCD % yield more than 3.5 times that of Example 1 where Ex. 1-(Sn) uses 55/45 mole % cis/trans-TMCD and Ex. 4-(Li/Al) uses 95/5 mole % cis/trans-TMCD).

In comparing Examples 1 and 9, Example 9 demonstrated improvement in TMCD % yield more than 3.3 times that of Example 1 where Ex. 1-(Sn) uses 55/45 mole % cis/trans-TMCD and Ex. 9-(Ti/Zn) uses 95/5 mole % cis/trans-TMCD).

All of these comparisons demonstrated unexpected results.

Additionally, use of the Li/Al and the Ti/Zn catalyst systems resulted in good inherent viscosities, e.g., (0.50 dL/g or greater, or 0.55 dL/g or greater) and a good b* value (less than 6) as compared to the Sn catalyst system, especially when the trap was not changed. This was also unexpected.

While Sn demonstrated similar inherent viscosities and color, it is unpredictable that the Li/Al and Ti/Zn catalyst achieved nearly the same inherent viscosities and color values. This is true for Examples 1, 3 and 8 (55/45 mole % cis/trans-TMCD) as well as for Examples 2, 5-7, and 9 (95/5 mole % cis/trans-TMCD). When yield data is collected, this means a trap was changed during the run, such as in Example 4. In Examples 5-7, the trap was not changed.

This disclosure has been described in detail with particular reference to preferred embodiments thereof, but it will be understood that variations and modifications can be effected within the spirit and scope of the disclosure.

1. A polyester composition comprising
(a) a dicarboxylic acid component comprising:
(i) 70 to 100 mole % of terephthalic acid residues;
(ii) 0 to 30 mole % of aromatic dicarboxylic acid residues having up to 20 carbon atoms; and
(iii) 0 to 10 mole % of aliphatic dicarboxylic acid residues having up to 16 carbon atoms;
(b) a glycol component comprising:
(i) 10 to 50 mole % 2,2,4,4-tetramethyl-1,3-cyclobutanediol, which is a combination of greater than 80 mole % of cis-2,2,4,4-tetramethyl-1,3-cyclobutanediol and less than 20 mole % of trans-2,2,4,4-tetramethyl-1,3-cyclobutanediol, or greater than 85 mole % of cis-2,2,4,4-tetramethyl-1,3-cyclobutanediol and less than 15 mole % of trans-2,2,4,4-tetramethyl-1,3-cyclobutanediol, or greater than 90 mole % of cis-2,2,4,4-tetramethyl-1,3-cyclobutanediol and less than 10 mole % of trans-2,2,4,4-tetramethyl-1,3-cyclobutanediol, or greater than 95 mole % of cis-2,2,4,4-tetramethyl-1,3-cyclobutanediol and less than 5 mole % of trans-2,2,4,4-tetramethyl-1,3-cyclobutanediol;
(ii) 50 to 90 mole % of cyclohexanedimethanol residues
(iii) optionally, residues of at least one modifying glycol;
wherein the total mole % of the dicarboxylic acid component of the final polyester is 100 mole %;
wherein the total mole % of the glycol component of the final polyester is 100 mole %;
wherein the polyester composition further comprises: (i) lithium atoms and aluminum atoms; or (ii) titanium atoms and zinc atoms; or (iii) tin atoms; and
wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

2. (canceled)

3. The polyester composition of claim 1 comprising lithium atoms and aluminum atoms.

4. The polyester composition of claim 1 comprising titanium atoms and zinc atoms.

5-10. (canceled)

11. The polyester composition of claim 1 comprising tin atoms in an amount from 0 to 30 ppm, relative to the mass of final polyester being prepared.

12. The polyester composition of claim 1 comprising titanium atoms in an amount from 0 to 30 ppm, relative to the mass of final polyester being prepared.

13. The polyester composition of claim 1, comprising manganese atoms in an amount from 0 to 30 ppm, relative to the mass of final polyester being prepared.

14. The polyester composition of claim 1 comprising zinc atoms in an amount from 0 to 30 ppm, relative to the mass of final polyester being prepared.

15. The polyester composition of claim 1 comprising germanium atoms in an amount from 0 to 30 ppm, relative to the mass of final polyester being prepared.

16. The polyester composition of claim 3, wherein lithium atoms are present in the final polyester in the amount of from 10 ppm to 100 ppm, and/or wherein aluminum atoms in the final polyester are present in the amount of from 10 ppm to 100 ppm, relative to the mass of final polyester being prepared.

17. (canceled)

18. The polyester composition of claim 3, wherein the ratio of lithium atoms to aluminum atoms in ppm relative to the mass of final polyester being prepared is from 1:5 to 5:1, and wherein the total catalyst metal atoms of lithium and aluminum present in the final polyester is in the range of from 10 to 1000 ppm, relative to the mass of final polyester being prepared.

19. (canceled)

20. The polyester composition of claim 3, wherein at least one lithium source is selected from lithium carbonate, lithium acetate, lithium benzoate, lithium succinate, lithium acetylacetonate, lithium methoxide, lithium oxalate, lithium nitrate, lithium ethoxide, lithium hydroxide, lithium hydride, lithium glycoxide, or alkyl lithium, lithium aluminum hydride, lithium borohydride, lithium oxide; or wherein at least one lithium source is lithium acetylacetonate; and/or wherein at least one aluminum source is selected from aluminum hydroxide, aluminum acetate, aluminum benzoate, aluminum sulfate, aluminum lactate, aluminum laurate, aluminum stearate, aluminum alcoholates, aluminum ethylate, aluminum isopropoxide, aluminum trin-butyrate, aluminum tri-tert-butyrate, mono-sec-butoxyaluminum diisopropylate, and aluminum chelates, ethyl acetoacetate aluminum diisopropylate, aluminum tris(ethyl acetoacetate), alkyl acetoacetate, aluminum diisopropylate, aluminum monoacetylacetate bis(ethyl acetoacetate), aluminum tris(acetyl acetate), or aluminum acetylacetonate; or wherein at least one aluminum source is selected from aluminum hydroxide, aluminum acetylacetonate, aluminum acetate, aluminum isopropoxide or aluminum sulfate; or wherein at least one aluminum source is selected from aluminum acetylacetonate and aluminum isopropoxide.

21. (canceled)

22. The polyester composition of claim 4, wherein the final polyester comprises titanium atoms in the amount of from 20 to 1000 ppm, and/or wherein the final polyester comprises zinc atoms in the amount of from 50 to 1000 ppm, relative to the mass of final polyester being prepared.

23.-24. (canceled)

25. The polyester composition of claim 22, wherein the ratio of titanium atoms to zinc atoms in ppm relative to the mass of final polyester being prepared is from 0.50-1:5 to 5:1.

26. The polyester composition of claim 4, wherein at least one titanium source is selected from at least one of titanium carbonate, titanium acetate, titanium benzoate, titanium succinate, titanium isopropoxide, titanium methoxide, titanium oxalate, titanium nitrate, titanium ethoxide, titanium hydroxide, titanium hydride, titanium glycoxide, alkyl titanium, titanium zinc hydride, titanium borohydride, titanium oxide, titanium acetylacetonate oxide, titanium tri-isopropoxide chloride, titanium bis(acetylacetonate)di-isopropoxide, titanium n-butoxide, titanium tert-butoxide; or wherein at least one titanium source is selected from at least one of titanium dioxide, titanium isopropoxide, titanium acetylacetonate oxide, titanium bis(acetylacetonate)di-isopropoxide and/or combinations thereof; and/or wherein at least one zinc compound selected from zinc borate, zinc oxide, zinc naphthenate, zinc tert-butoxide, zinc methoxide, zinc hydroxide, zinc acetate, zinc diacetate, zinc dihydrate, zinc octoate, zinc carbonate, dialkyl zinc, dimethyl zinc, diaryl zinc, zinc isopropoxide, zinc phosphate, and/or zinc acetylacetonate; or comprising a catalyst system further comprising at least one zinc compound selected from zinc acetylacetonate and zinc isopropoxide.

27.-28. (canceled)

29. The polyester composition of claim 1, wherein the total percentage yield of 2,2,4,4-tetramethyl-1,3-cyclobutanediol residues is at least 0.50% or greater, as compared to when 55/45 mole % cis/trans-2,2,4,4-tetramethyl-1,3-cyclobutanediol is used for each catalyst system; or wherein the total percentage yield of 2,2,4,4-tetramethyl-1,3-cyclobutanediol residues using a catalyst system that does not comprise tin is at least 0.5% or greater, as compared to where 95/5 mole % cis/trans-2,2,4,4-tetramethyl-1,3-cyclobutanediol is used in combination with tin as the catalyst system.

30-31. (canceled)

32. A process for making at least one polyester comprising
(a) a dicarboxylic acid component comprising:
(i) 70 to 100 mole % of terephthalic acid residues;
(ii) 0 to 30 mole % of aromatic dicarboxylic acid residues having up to 20 carbon atoms; and
(iii) 0 to 10 mole % of aliphatic dicarboxylic acid residues having up to 16 carbon atoms;
(b) a glycol component comprising:
(i) 10 to 50 mole % TMCD, which is a combination of greater than mole % of cis-TMCD and less than 20 mole % of trans-TMCD, or greater than 85 mole % of cis-TMCD and less than 15 mole % of trans-TMCD, or greater than 90 mole % of cis-TMCD and less than mole % of trans-TMCD, or greater than 95 mole % of cis-TMCD and less than 5 mole % of trans-TMCD;
(ii) 50 to 90 mole % of cyclohexanedimethanol residues
(iii) optionally, residues of at least one modifying glycol;
said process comprising the following steps:
(I) heating a mixture of at least one temperature chosen from 150° C. to 300° C., under at least one pressure chosen from the range of 0 psig to 100 psig wherein said mixture comprises:
(a) a dicarboxylic acid component comprising:
(i) 70 to 100 mole % of terephthalic acid residues;
(ii) 0 to 30 mole % of aromatic dicarboxylic acid residues having up to 20 carbon atoms; and
(iii) 0 to 10 mole % of aliphatic dicarboxylic acid residues having up to 16 carbon atoms;
(b) a glycol component comprising:
(i) 10 to 50 mole % TMCD residues, which is a combination of greater than 80 mole % of cis-TMCD and less than 20 mole % of trans-TMCD, or greater than 85 mole % of cis-TMCD and less than mole % of trans-TMCD, or greater than 90 mole % of cis-TMCD and less than 10 mole % of trans-TMCD, or greater than 95 mole % of cis-TMCD and less than 5 mole % of trans-TMCD;
(ii) 50 to 90 mole % of cyclohexanedimethanol residues
(iii) optionally, residues of at least one modifying glycol;
wherein the molar ratio of glycol component/dicarboxylic acid component added in Step (I) is 1.0-1.5/1.0;
(II) heating the product of Step (I) at a temperature of 230° C. to 320° C. for 1 to 6 hours, under at least one pressure chosen from the range of the final pressure of Step (I) to 0.02 torr absolute, to form a final polyester;
wherein the total mole % of the dicarboxylic acid component of the final polyester is 100 mole %;
wherein the total mole % of the glycol component of the final polyester is 100 mole %;
wherein the mixture in Step (I) is heated in the presence of at least one catalyst system comprising:
(i) at least one lithium compound and at least one aluminum compound; or
(ii) at least one titanium compound and at least one zinc compound; or
(iii) at least one tin compound, or
wherein the mixture in Step (I) is heated in the presence of a first catalyst, and Step II is heated in the presence of a second catalyst, and wherein the catalyst system comprises one of the following:
(i) the first catalyst comprises at least one lithium compound and the second catalyst comprises at least one aluminum compound; or
(ii) the first catalyst comprises at least one titanium compound and a second catalyst comprising at least one zinc compound; and
wherein the inherent viscosity of the final polyester is from 0.35 to 1.2 dL/g as determined in 60/40 (wt/wt) phenol/tetrachloroethane at a concentration of 0.25 g/50 ml at 25° C.; and wherein the final polyester has a Tg from 85° C. to 150° C.

33.-34. (canceled)

35. The process of claim 32 wherein the catalyst system comprises lithium atoms and aluminum atoms.

36. The process of claim 32 wherein the catalyst system comprises titanium atoms and zinc atoms.

37.-39. (canceled)

40. The process of claim 35, wherein the catalyst system comprises at least one lithium compound and at least one aluminum compound; wherein the total percentage yield of 2,2,4,4-tetramethyl-1,3-cyclobutanediol residues is at least 1.0% or greater, as compared to when 55/45 mole % cis/trans-2,2,4,4-tetramethyl-1,3-cyclobutanediol is used with a tin catalyst system; or wherein the catalyst system comprises at least one lithium compound and at least one aluminum compound, wherein the improvement in TMCD % yield is 1.5 more times the % yield 2,2,4,4-tetramethyl-1,3-cyclobutanediol, as compared when tin is the catalyst system, wherein each process uses 95/5 mole % cis/trans-2,2,4,4-tetramethyl-1,3-cyclobutanediol; or wherein the catalyst system comprises at least one lithium compound and at least one aluminum compound, wherein the improvement in TMCD % yield is 1.5 more times the % yield, as compared to when 55/45 mole % cis/trans-2,2,4,4-tetramethyl-1,3-cyclobutanediol is used with a tin catalyst system.

41. The process of claim 36 wherein the catalyst system comprises at least one titanium compound and at least one zinc compound; wherein the total percentage yield of 2,2,4,4-tetramethyl-1,3-cyclobutanediol residues is at least 1.0% or greater, as compared to when 55/45 mole % cis/trans-2,2,4,4-tetramethyl-1,3-cyclobutanediol is used with a tin catalyst system; or wherein the catalyst system comprises at least one titanium compound and at least one zinc compound; wherein there is an improvement in TMCD % yield of 1.5 more times the % yield of 2,2,4,4-tetramethyl-1,3-cyclobutanediol, as compared to when tin is the catalyst system, and wherein each process uses 95/5 mole % cis/trans-2,2,4,4-tetramethyl-1,3-cyclobutanediol.

42. (canceled)
